(19) United States
(12) Patent Application Publication
(10) Pub. No.: US 2013/0205189 A1
(43) Pub. Date: Aug. 8, 2013

(54) Apparatus And Method For Interacting With An Electronic Form

(71) Applicant: Advanced Digital Systems, Inc., Durham, NC (US)

(72) Inventors: Christopher M. DiPierro, Durham, NC (US); David R. Nakamura, Edmonds, WA (US); Gregory J. Clary, Cary, NC (US)

(73) Assignee: Advanced Digital Systems, Inc., Durham, NC (US)

(21) Appl. No.: 13/750,129

(22) Filed: Jan. 25, 2013

Related U.S. Application Data
(60) Provisional application No. 61/590,598, filed on Jan. 25, 2012.
(60) Provisional application No. 61/678,383, filed on Aug. 1, 2012.
(60) Provisional application No. 61/715,534, filed on Oct. 18, 2012.

(51) Int. Cl. G06F 3/0483

(52) U.S. Cl. CPC G06F 3/0483
USPC 715/224

(57) ABSTRACT

An apparatus is provided that is caused to receive a form definition for a multi-page electronic form including a plurality of fields. The apparatus is caused to display the form in accordance with the form definition, including in at least one instance, display of a focused one of the pages in its entirety. The apparatus is also caused to receive an indication of user interaction with the displayed page of the form; and in response to receipt of the indication, process events in accordance with a defined interactive behavior of the displayed form. The events include one processed without regard to user interaction with any field of the displayed page, such as to transition focus to the non-focused page in response to user interaction with the non-focused page. The non-focused page may thereby become the focused page, and the focused page may become the non-focused page displayed only partially.

### CROSS-REFERENCE TO RELATED APPLICATION(S)

The present application claims priority to U.S. Provisional Patent Application No. 61/590,598, entitled: Apparatus and Method for Processing an Electronic Form, filed on Jan. 25, 2012, U.S. Provisional Patent Application No. 61/678,383, entitled: Apparatus and Method for Automatically Transforming a Form for Completion on a Mobile Device, filed on Aug. 1, 2012, and U.S. Provisional Patent Application No. 61/715,534, entitled: Apparatus and Method for Interacting with an Electronic Form, filed Oct. 18, 2012, the contents of all of which are incorporated herein by reference in their entireties.

### TECHNOLOGICAL FIELD

The present disclosure relates generally to electronic forms and, in particular, to interacting with electronic forms.

### BACKGROUND

Electronic forms in recent years have been completed using the mouse and keyboard. The mouse and keyboard are used for selecting fields, entering data into fields, initiating events and the like. New mobile devices provide pen input capability and touch input capability. Furthermore, display systems on these new devices are capable of rapidly zooming to enlarge a portion of the screen. Mobile device users expect highly responsive user interfaces and large touch-friendly targets such as buttons or menu items. Thus, there is a need for new methods for interacting with form fields, initiating events, displaying forms, selecting forms and/or accessing forms. In addition, electronic forms typically provide areas that are not responsive to events such as mouse clicks, touches on a touch sensitive screen or taps with a pen stylus, such as areas outside of form fields.

### BRIEF SUMMARY

According to one aspect of example implementations of the present disclosure, an apparatus is provided that includes a processor and a memory storing executable instructions that in response to execution by the processor cause the apparatus to perform a number of operations. According to this aspect, the apparatus is caused to receive a form definition for a multi-page electronic form including a plurality of fields one or more of which accept input. The apparatus is caused to display the form in accordance with the form definition, including in at least one instance, display of a focused one of the pages in its entirety. One or more of the fields include respective controls for user interaction with the form, and the controls for fields on the focused page may be active.

The apparatus is also caused to receive an indication of user interaction with the displayed page of the form; and in response to receipt of the indication, process a plurality of events in accordance with a defined interactive behavior of the displayed form. In this regard, the events include one processed without regard to user interaction with any field of the displayed page.

In one example, the apparatus being caused to display the form includes being caused to further display another, non-focused one of the pages only partially. In this example, the controls for the fields on the non-focused page may be inactive.

In one example, the apparatus being caused to process the event without regard to user interaction with any field may include being caused to transition focus to the non-focused page in response to user interaction with the non-focused page. The non-focused page may thereby become the focused page displayed in its entirety and with the controls for its fields being active, and the focused page may become the non-focused page displayed only partially and with the controls for its fields being inactive.

Other examples of an event processed without regard to user interaction with any field may include the apparatus being caused to display a menu over a portion of the displayed page in response to user interaction with the respective portion of the displayed page. The apparatus may be caused to expand a menu to include a sub-menu in an instance in which the menu is displayed over a portion of the displayed page, and in response to user interaction with the menu. The apparatus may be caused to launch a browser to display a web site corresponding to a logo on the displayed page in response to user interaction with the logo. The apparatus may be caused to display information about a picture on the displayed page, or activate a camera to take a replacement picture, in response to user interaction with the picture. The apparatus may be caused to capture electronic ink data on a portion of the displayed page outside any field and without being associated with any field, in response to user interaction with the respective portion of the displayed page. The apparatus may be caused to add a field to the displayed page in response to user interaction with the displayed page outside of any field of the displayed page. The apparatus may be caused to display a desktop note over a portion of the displayed page that accepts input. The apparatus may be caused to launch a browser to display a web site corresponding to a caption associated with but located in a pre-defined spatial area outside of a field on the displayed page, in response to user interaction with the respective caption. The apparatus may be caused to display or play context information, or display validation information, for the form or one or more fields of the form, in response to user interaction with a pre-defined spatial area outside of any field.

In various examples, the apparatus may be caused to process an event with regard to user interaction with a field of the displayed page. These events may include, for example, the apparatus being caused to change an input value in a field of the focused page in response to user interaction with the respective field. The apparatus may be caused to focus on a field of the focused page to accept input in the respective field in response to user interaction with the respective field. The apparatus may be caused to set focus on a box of a multi-box field of the focused page to accept input in the respective box, in an instance in which the display is focused on the multi-box field, and in response to user interaction with the respective box. The apparatus may be caused to display or play context information for a field in response to user interaction with a caption associated with the respective field. In these examples, for changing the input value, focusing on the field or setting focus on the box, the apparatus may be further caused to update display of the page of the form to contain the changed input value, or the input accepted into the field or box.

In various examples, the pages of the multi-page form may be ordered and include at least a first page and a second page after the first page. In at least one instance, the first and second pages may correspond to respective ones of the focused and non-focused pages; and in this instance, the apparatus may be caused to display the first page centered and in its entirety, and display only a left-most part of the second page to the right of the first page. In at least one other instance, the first and second pages may correspond to respective ones of the non-focused and focused pages; and in this instance, the apparatus may be caused to display the second page centered and in its entirety, and display only a right-most part of the second page to the left of the first page. In a further example, the pages of the multi-page form may further include a third page after the second page. In this further example, in at least one instance in which the first and second pages correspond to respective ones of the non-focused and focused pages, the third page may also correspond to a non-focused page. In this instance, the apparatus may be caused to further display only a left-most part of the third page to the right of the second page.

In various examples, the pages of the form may include context information identifying the respective pages. In these examples, the apparatus may be caused to process a plurality of events further including at least briefly displaying and then fading from display the context information for at least the focused page and non-focused page. Additionally or alternatively, in these examples, the apparatus may in at least one instance, display of all of the pages of the form in their entireties, and further display of the context information for the respective pages.

In various examples, the apparatus may be caused to process a plurality of events further including focusing on a field of the focused page to accept input in the respective field in response to user interaction with the respective field. In these examples, the apparatus may auto-zoom the respective field to a variable level that differs between at least two fields of the same form or different forms.

In other aspects of example implementations, a method and computer-readable storage medium are provided for interacting with an electronic form. The features, functions and advantages discussed herein may be achieved independently in various example implementations or may be combined in yet other example implementations further details of which may be seen with reference to the following description and drawings.

### BRIEF DESCRIPTION OF THE DRAWING(S)

Having thus described the technological field of the present disclosure in general terms, reference will now be made to the accompanying drawings, which are not necessarily drawn to scale, and wherein:

FIG. 1 is an illustration of a system in accordance with an example implementation;

FIG. 2 is an illustration of a server and client according to one aspect of example implementations;

FIG. 3 is an illustration of a form designer, server and client according to another aspect of example implementations;

FIG. 4 is an illustration of a form designer, server and client according to yet another aspect of example implementations;

FIGS. 5 and 6 are illustrations of example menu interfaces in accordance with example implementations;

FIGS. 7-16 are illustrations of displays that may be presented in accordance with one aspect of example implementations;

FIGS. 17-48 are illustrations of displays that may be presented in accordance with another aspect of example implementations; and

FIG. 49 is an illustration of an apparatus that may be configured to operate or otherwise function as one or more of a form designer, server and client, according to example implementations.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. According to one example, the system may be referred to as the “Mi-Forms System,” and the server may be referred to as the “Mi-Forms Server.” Like reference numerals refer to like elements throughout.

Unless otherwise specified, the terms “data,” “content,” “information,” and similar terms may be used interchangeably, according to some example implementations of the present disclosure, to refer to data capable of being transmitted, received, operated on, entered into an electronic form, and/or stored. The term “network” may refer to a group of interconnected computers or other computing devices. Within a network, these computers or other computing devices may be interconnected directly or indirectly by various means including via one or more switches, routers, gateways, access points or the like.

Further, as described herein, various messages or other communication may be transmitted or otherwise sent from one component or apparatus to another component or apparatus, and various messages/communication may be received by one component or apparatus from another component or apparatus. It should be understood that transmitting a message/communication may include not only transmission of the message/communication, and receiving a message/communication may include not only receipt of the message/communication. That is, transmitting a message/communication may also include preparation of the message/communication for transmission, or otherwise causing transmission of the message/communication, by a transmitting apparatus or various means of the transmitting apparatus. Similarly, receiving a message/communication may also include causing receipt of the message/communication, by a receiving apparatus or various means of the receiving apparatus.

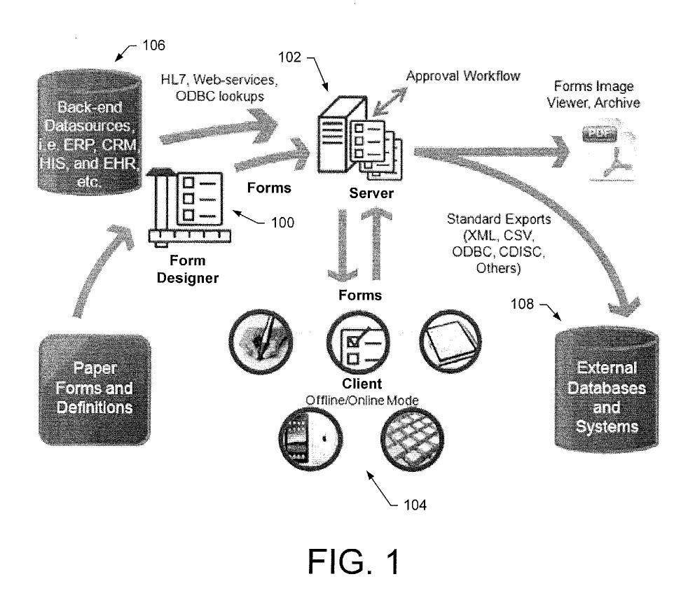

FIG. 1 depicts a system according to various example implementations of the present disclosure. As shown, the system includes one or more apparatuses configured to function as a form designer 100, server 102 and client 104, and which may be configured to communicate with one another directly or across one or more networks. The network(s) may include one or more wide area networks (WANs) such as the Internet, and may include one or more additional wire line and/or wireless networks configured to interwork with the WAN, such as directly or via one or more core network backbones. Examples of suitable wire line networks include area networks such as personal area networks (PANs), local area networks (LANs), campus area networks (CANs), metropolitan area networks (MANS) or the like. Examples of suitable wireless networks include radio access networks, wireless LANs (WLANs), wireless PANs (WPANs) or the like. Generally, a radio access network may refer to any 2nd Generation (2G), 3rd Generation (3G), 4th Generation (4G) (e.g., Long Term Evolution (LTE)) or higher generation mobile communication network and their different versions, radio frequency (RF) or any of a number of different wireless networks, as well as to any other wireless radio access network that may be arranged to interwork with such networks.

The system of example implementations may offer a suite of cross-platform solutions for data capture. It may provide an intuitive user experience of electronic forms design, on-site and off-site network connected or disconnected data collection, business rule enforcement, centralized electronic form and workflow management, and extensive backend system integration.

Electronic forms may be built either entirely by the form designer 100, or from existing form definitions like TeleForm Designer files, Adobe Portable Document Format (PDF) files, Microsoft Word files, Microsoft Excel files, Extensible Markup Language (XML) files or forms built in back-end enterprise software systems. Pre-designed forms may also be imported using a conversion tool or by the form designer itself. Then forms may be directly uploaded to the server 102 and deployed to various clients 104 for use thereon, such as for online or offline data entry.

When a user of a client 104 fills out a form, the system of example implementations may provide support for instant data lookups and updates to one or more back-end database systems 106. With embedded handwriting recognition technology, ink data may be immediately converted to text which may allow the user to verify and correct any mistakes or other errors. After completing a form, the user may choose to either directly upload the data from the client to the server 102 or save on the client and send later such as in the case of the client not having a persistent network connection. Once the server receives the form, an authorized user or administrator may effectively view and archive the form and other submitted forms. The server typically manages the workflow/approval queue of data, and exports necessary data to user-defined back-end databases. Form data may be exported in a number of different formats (e.g., PDF, XML, CSV, etc.) and saved to a network location or document repository system (e.g. DropBox, SkyDrive, etc.), or further integrated to external databases and systems 108 such as Microsoft Access, ODBC-compatible database systems, Microsoft SQL Server, Oracle and other systems via web services.

In a more particular example, the form designer 100 may enable a user to design custom forms for a variety of applications. The form designer may define the form's appearance, behavior and/or interaction with resources external to the form itself. In one example, the form designer includes three primary components, namely, a layout tool for form design, a business rule and scripting language for data verification and manipulation, and data import and export technology for communication with back-end databases and systems 106.

For layout there may be a series of tasks accomplished through drag-and-drop technology and dialogs within an appropriate designer. Much of the layout may be performed using toolbar buttons that allow for a wide range of data types and data collection objects to be included in the form, including fields that accept a defined set of characters in a defined order such as alpha fields of various lengths, numeric fields and/or alphanumeric fields; fields that provide selection(s) of defined options; fields that accept electronic “ink” in the form of handwriting, signatures, or free-hand drawing; fields that accept speech input; fields that accept input from a virtual or physical keyboard; a variety of specialized fields such as social security number and a wealth of date and time fields; and other fields that specialize in the presentation of data or in the collection of data. The form designer may also include images to further enhance the presentation of the form. And the form designer may also be capable of ordering, grouping and/or aligning objects.

A form may require simple business rules (e.g., required fields), cross-field validation rules (e.g., if gender is Male then question 5 must be greater than 8) or sophisticated consistency checking. With the form designer 100, each of these types of rules may be built into the form using a menu-driven business rule editor or directly coded via a business rule and scripting language within the designer.

The form may be further configured to integrate data with external data resources, such as an existing enterprise application or database. The form and system may support many modes of importing data from or exporting data to external systems. From the system or form, for example, data may be exported via ODBC, SQL, in XML files, or in comma-separated value (CSV) files. Images of forms and their ink may be exported in a number of different formats such as JPEG, GIF, TIFF, PNG, BMP, PDF or the like. In one example, a PDF may be exported containing discrete data. In one example, an external application may connect to a back-end database of the server 102, such as via ODBC, and push or pull exactly the data needed, including images of the ink for any given form element.

The form designer 100 may also allow for two-way communication between the form application and any back-end database, such as through ODBC. With this technology, the system of example implementations may allow for data fields to be dynamically filled such as from an enterprise's database before or during data collection on a client 104.

The server 102 may more particularly allow an enterprise to control the flow of data, manage accounts, implement predefined workflow, and/or deliver solution updates to users. The server may be configured to perform a number of functions including, for example, managing users, passwords, groups and privileges; managing form revisions, application software, “apps” and/or solution revisions; implementing forms-based workflow; centralized data exporting including custom data exports from script; or the like. In various examples, the server may also support digital pen data such as to accommodate a client 104 that supports digital pen data capture.

Additionally or alternatively, for example, the server 102 may be configured to implement server-side script code such as using the same APIs and event model as the client 104; or to implement open web-services such as communication over HTTP/HTTPS that may be integrated with software development kit (SDK) built applications; or the like. Even further, the server may be configured to implement one or more centralized management functions, such as carrying out data validations, supporting workflow via a concept of queuing, enabling data and form sharing between individual users or groups, routing forms based on data content such as automatically via script code or via user interaction at form-finish time, or the like. Using the server, an administrator or other user may create a predefined workflow pattern. The data collected may move automatically to the next user or group.

Whether implemented as a standalone application or as a client application with the server 102, the client 104 may provide or otherwise enable a number of steps in data capture including, for example, pre-fill, capture, verify and validate, and/or communicate. For example, the client may pre-fill a form with data a user already has, such as by pulling data from another source (e.g., a database, another form in the system, or another previously existing document) and using it as pre-fill information in a form. This may reduce the amount of information needing to be captured, reduce possible errors introduced without pre-fill data, and/or allow captured data to be linked back to the original record source, if needed. Data may be captured on a number of different devices, such as using a smartphone, tablet computer, laptop computer, desktop computer, digital pen or the like. The client may be configured to convert handwriting into machine readable text as the user writes. Drawings, diagrams and/or a number of other data sources may also be captured if needed (e.g., photos, images, audio, barcodes, RFID data, GPS location data, attachments of any files, etc). On various devices, the client may allow for keyboard (e.g., physical keyboards, onscreen virtual keyboards or their equivalent input replacement) and mouse entry interface for capturing data. The client may further support digital pen data capture, such as through filling a paper-based form with a digital pen that may capture ink data which may be captured by client or server and converted into machine-readable form. The client may also respond appropriately to touch-based input gestures (e.g., touch, tap, swipe, pinch, etc).

The client 104 may be configured to verify handwriting recognition results and validate data relationships (e.g., date/time evaluation, business rules, etc.) on the form. On various devices, the client may be configured to perform verification and validation checks as the user collects data in real-time, at the ‘scene’ of data collection. For other devices such as digital pens, the client may perform verification and validation checks when the pen is docked or when its data is transmitted to the server or to a smartphone, for example.

The client 104 may be further configured to communicate and share data with other apparatuses, such as existing enterprise systems. In one example, data may be exported from the client to the server 102 and then to other existing data repositories or data may be exported directly from the client. Recognized data (text), ink, form page background data and the like may be exported via a variety of formats (e.g., CSV, XML, ODBC, SQL, MSJet, Outlook, PDF, variety of image formats, etc.). Data exports may also be customized for greater flexibility in exporting data to an existing data system (e.g., HL7, SVG, etc.).

Although not separately shown, the system of example implementations may further include an SDK. The SDK is generally a development toolkit for integrating handwriting recognition and mobile data capture into software and applications, such as to develop form-based applications or to equip a software product with a digital handwriting or touch input feature. The system may include a form component, which as a forms-processing engine, may be configured to interpret a form built with the form designer 100. The form component of the SDK may optionally provide the user interface, manage data collection, and ultimately, output the data to other systems. In this regard, the component of the SDK may be used in a variety of ways such as within a custom application, in a Web-based application deployed to web browser clients, as a part of a dedicated client, within a server application as a data formatting apparatus, or the like.

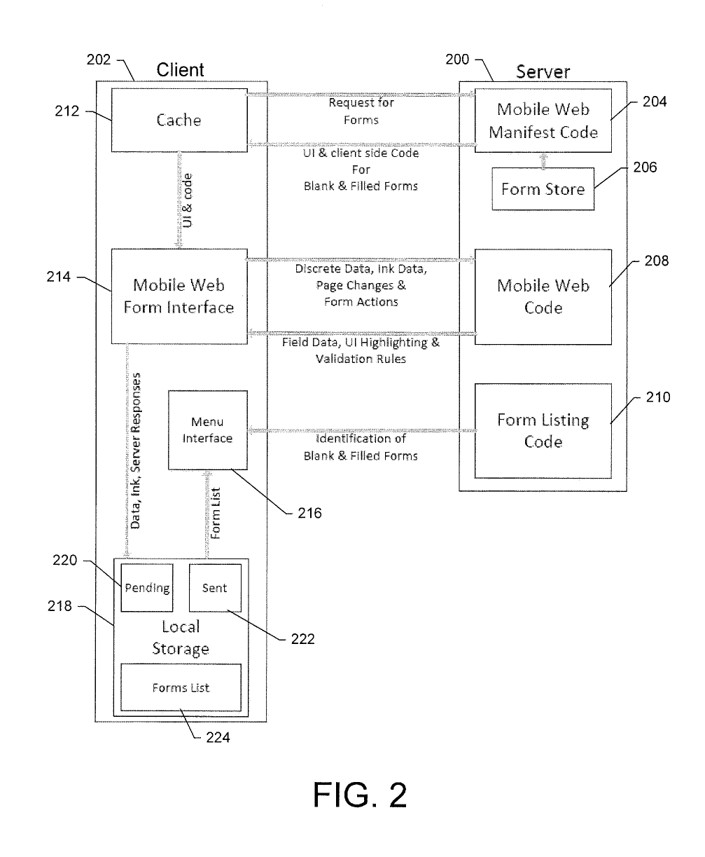

The form designer 100, server 102 and/or client 104 may be arranged in a number of different manners to perform a number of different functions. Reference will now be made to FIGS. 2, 3 and 4, which illustrate one or more of the foregoing components according to aspects of example implementations of the present disclosure. The aspects described with respect to FIGS. 2, 3 and 4 may operate independent of one another, or in various examples, may operate together in various combinations.

A. Processing an Electronic Form

According to one aspect of example implementations of the present disclosure, the server 102 and client 104 may interact according to HTTP communication, and the client may be implemented by a web browser through execution of computer-readable program code, such as HTML5 and/or JavaScript. In operation according to one example, the server may produce a menu system that displays a list of available blank and filled electronic forms for the client user. It does this by providing the HTML5 and JavaScript (JS) code to the web browser on the client. This JS code may then make web service calls to the server to ask it what blank forms are allowed to the user, what filled forms correspond to those blank forms, etc. It may take the responses from the server, store them in the browser's local storage (an HTML5 feature) and build a user interface (UI) from this list. Additionally, it may instruct the browser to download a manifest. This manifest may be a list of resources each designated by a URL for the browser to download and cache for offline use, and each URL may correspond to a blank form, filled form, or other auxiliary resource (e.g. JS code, an image, audio, etc.) that the browser may need in offline mode.

Behind the scenes, the client 104 (browser) may make a request to all of the URLs provided in the manifest and begin to cache them. As it does so, it may provide events as to its cache status to JS code in the menu described above that may be used as a sort of running animation of cache status. This running animation may manifest itself as a spinning icon or any other appropriate visual queue. Once complete, the client may visually indicate this to the user such that they know the system is ready to be used both online and offline, via icons and the changes in state of those icons. The UI that was constructed above may include links to the same URLs that were cached such that when a user clicks or touches one, the client may be directed to open that URL and display it from cache.

When the client 104 caches forms, it may make a request that instructs the server 102 to provide an HTML5 representation of a given form. The server may carry out this function by looking in its template store and opening it up inside the aforementioned SDK. It may iterate through controls on pages of the given form, and create an HTML5 layout that corresponds to the form. This layout may or may not be spatially true to the original layout created in the form designer. In instances in which the layout is not spatially true to the original layout, the server may discard positional X/Y information and instead group fields together based on a property known at design time as a web group, and “figure out” the proper HTML formatting of the field based on field type, highlighting, current data content, etc. In the end, the form may be represented as a single HTML resource that through the use of hidden panels and other elements may represent all pages or screens in the actual form template. It may be this content (along with JavaScript code) that the client locally caches.

When a client user touches or clicks on a link corresponding to a given form, the client 104 may quickly display the previously cached HTML page. It may also activate embedded JS code, which may first attempt to communicate with the server 102 through the use of a web service that may be referred to as “EstablishSession.” In this regard, the JS code may need to inform the server that a new faun has been opened on the client device, and it wants the server to start processing it. If this is successful, the client code may store some meta-information about the form that the server sent back. If it was unsuccessful (offline), the client may know to attempt this again at a later time and auto-retry at a specific interval.

From there, any time the user manipulates the form (e.g. enters data, changes a page, inks on a control, etc.), the client JS code may do two things. First, it may track manipulations and/or data in the client's 104 local storage such that it may be replayed at a later time. Second, it may attempt to inform the server 102 about the manipulation via web service. If this succeeds, the client may know that the server has a form that is in sync with what the user is doing. If not, the client may store it and attempt to tell the server about the change at a later time. In various instances, such as in the online case, the server may process the event and if that caused any changes (e.g., validation rule violations, script code causing other fields to be filled, etc.) the web service response will indicate this and the JS code in the client will update its UI appropriately. This goes on repeatedly as the user fills the form until they indicate that they are finished with it. In various instances, such as in the offline case, they may locally save the form and then resume it later. In various instances, such as in the online case, they may also finish the form which tells the server to process it (e.g., run exports, workflow, etc.) and remove it from the local client store.

In the case of already partially filled forms, the process may be similar. But in this case, if the user has made changes to the form that have not been communicated to the server 102, when the URL is opened, the JS code looks at those unsent changes and simulates (replays) the user having performed them again. In this way, having to save the entirety of an HTML form page may be avoided, and instead, just the data changes that took place may be stored.

FIG. 2 illustrates a server 200 that may be configured to operate as server 102, and a client 202 that may be configured to operate as a client 104, according to one example implementation. As shown in FIG. 2, the server of one example may be configured to process forms and requests, and may include mobile web manifest code 204, a form store 206, mobile web code 208 and form listing code 210. The mobile web manifest code may be code that produces a list of resources the client may cache and then fulfills requests from the client to get those resources. The form store may be a repository (database or otherwise) of forms. The mobile web code may be code that is able to interpret a form file and respond to state changes reported by the client returning a correctly formatted response such that the client can further update its state as necessary. And the form listing code may be code that determines the forms to which a given user has permissions.

Generally, the client 202 shown in FIG. 2 may be configured to operate as a client 104 through execution of computer-readable program code, such as HTML5 and/or JavaScript, to carry out one or more functions. In this regard, the client may include an HTML5-compliant web browser that supports manifest caching and code execution. The client may include a cache 212, mobile web form interface 214, a menu interface 216 and local storage 218. The cache may be a repository that stores resources the server 200 instructs it to store. The mobile web form interface may be in essence a web page that displays UI elements and makes events available to client side code at the appropriate time. And the menu interface may be a UI that displays a list of available forms to the user based on what is currently in local storage in the client as well as queried forms lists from the server.

The local storage 218 of the client 202 may be a repository made available to a specific web application that can be used to store arbitrary data. In one example, the local storage may be further divided into pending 220, sent 222 and forms list 224. The pending local storage may be for data that has been modified in the client but not yet reported to the server. The sent local storage may be for data that was modified in the client, sent to the server and responded to but may still be needed for the purposes of later synchronization. And the forms list local storage may be for a listing of blank and filled forms that can be queried to display the menu interface 216 in an offline state.

In one example, a user may log in to the menu interface 216 and be presented with a list of available blank forms which may be identified as T1, T2, . . . TN. This initial forms list may be created by combining responses from the form listing code 210 and forms list local storage 224. In the background, the client 202 may have been informed by the mobile web manifest 204 that it should cache a list of resources. The client may begin to make these requests behind the scenes without user intervention. Each request may be passed through the mobile web manifest code and the appropriate response may be given. All forms to which the user has access may be stored in the forms list local storage 224.

The user may choose to begin form T1 by clicking/tapping on it. In response, the client 202 may check its cache 212. If the resources corresponding to T1 are in the cache, the client may use those. If not, the client may query the mobile web code 208 of the server 200 to get the resources it needs. In the case where resources are not cached and a connection is not available, the user may be presented with an error message. The forms list local storage 224 may be updated to indicate that a new filled form has been created based on T1. And a mobile web form interface 214 may be displayed and initialized.

The mobile web form interface 214 may attempt to contact the mobile web code 208 on the server 200 to let it know that a new filled form (dubbed a session) is being created. If successful, the server may return a unique session identification, which in one example may be referred to as S1. In this case, S1 and the mobile web form interface 214 may update the forms list local storage 224. This may also cause the manifest 204 to indicate a change which may or may not cause the client 202 to update its cache 212. If the server connection is unavailable, the local JS code may assign the filled form a temporary identifier (LS1) and reconcile this with the server when a connection again becomes available using the aforementioned EstablishSession web service.

The user may make some change to the form such as entering data into a field. In response, the data may be immediately recorded in pending local storage 220. The mobile web form interface 214 may attempt to contact the mobile web code 208 of the server 200 with the state change. If successful, the data may be moved from pending local storage to sent local storage 222 along with the server's state change responses. The mobile web form interface may update the user interface as needed. If the server connection is unavailable, the change may remain in pending local storage.

At some point, the user may choose to close the form such that they may continue it later. In this instance, the mobile web form interface 214 may close and the menu interface 216 may reappear.

Now consider the case in which the user desires to fill an already partially-filled form. The user may see the form S1 from above as a sub-item of T1 and click/tap it from the menu interface 216. Additionally this menu system may allow the user to group items by other logical groupings such as workflow queues and switch between those views. Local JS code may reconcile the state of the client 202 cache status and display a link (URL) that is appropriate to reopen S1 whether the entirety of S1's resources are cached or whether JS code may need to use T1 resources along with local storage data to reconstruct S1.

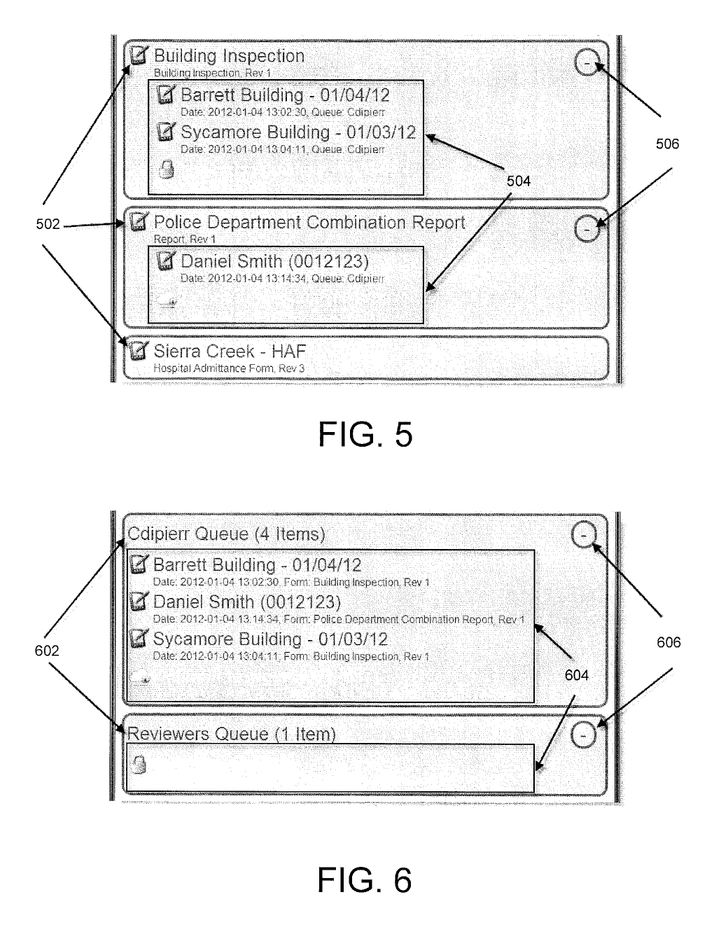

FIG. 5 illustrates an example menu interface that may correspond to the menu interface 216 of FIG. 2. The menu interface may identify each form 502 to which a given user has permissions, and as shown, forms may be grouped together in form grouping areas by form, three examples of such areas being shown. Each form may be used as a heading for a form area, and in the example shown, this heading may display a tablet icon to the left, the form's name in the top row and a combination of the form's description and revision in a second row. In one example, clicking/tapping on any portion of this header may launch a new instance of the form and bring up the form filling interface for that form.

As also shown in FIG. 5, if a form 502 has one or more filled (including partially-filled) instances 504, a grouping button 506 may appear in the menu interface. In one example, clicking/tapping on this button may toggle the visibility of filled forms corresponding to this form. When grouped by form, filled instances of a given form type may be displayed as rows under the blank form header. Each row may correspond to a single filled instance of the form. In one example, this row may be subdivided into two additional rows. One of these additional rows may display a form status icon to the left and the filled form's descriptor to the right, and the other may display the date on which the form was last modified and a queue in which the form currently resides.

The menu interface may include any of a number of different status icons. For example, a tablet icon may indicate the form is available for use both when connected and disconnected from the network. A cloud icon may indicate the form is available for download, but not available on the device; clicking/tapping this icon may download the form. And a lock icon may indicate the form is locked to another user and cannot be opened. In one example, for forms that have the tablet icon, clicking/tapping on that icon or either of the text rows, may launch the form filling interface for that form.

FIG. 6 illustrates another example menu interface that in may correspond to the menu interface 216 of FIG. 2. The menu interface of FIG. 6 may be similar to that of FIG. 5, but may group forms together in queue grouping areas by queue, two examples of such areas being shown. Each queue area may include a heading identifying a respective queue 602. This heading may display the name of the queue and the number of filled (including partially-filled) forms in that queue. If a queue has one or more filled forms 604, similar to before, a grouping button 606 may appear in the menu interface.

When grouped by queue, filled instances of a given form type may be displayed as rows under the queue header. Each row may correspond to a single filled instance of the form. This row may be subdivided into two additional rows. One of these additional rows may display a form status icon to the left and the filled form's descriptor to the right, and the other may display the date on which the form was last modified and the form template from which it was originally created. In one example, the status icon may be any of a number of different status icons such as those described above, and clicking/tapping the icon or either of the text rows may launch the form filling interface for that form.

The mobile web form interface 214 may be displayed. In the case in which T1 is opened, the sent and pending local storage 220, 222 may both be queried. Data changes recorded therein and responses from the server 200 may be “replayed” in that the interface may be made to match how the user last left the form. If opening S1, then only the pending local storage may be queried for replay. In both cases, the act of replaying may be performed through embedded code where items may be simulated in the same way as if the user had performed those actions, so as an example text may be entered into textboxes, checkboxes are checked, etc. From here, the process may be substantially if not entirely the same as in the blank form case.

As another meaningful action, a user may finish a form. This option may be available if the mobile web form interface 214 has determined that the server 200 is available. If so, it may inform the mobile web code 208 that the form is to be finished and, assuming that message is successfully received, may remove all traces of that data from the local storage 218. If a server connection was not available at last user action, a finish option may not be provided to the user. If the finish option was available and connectivity has since been lost, the user may be presented with an error message.

As described herein, a designer may create forms in the system, and those forms defined according to the system may be rendered by the system for presentation or filling on any of paper, paper for digital pen filling (e.g., Anoto functionality digital pen filling), paper for scanning, Ricoh eQuill, smartphone, iPad, Android slate, Kindle Fire, WebOS device, Windows Tablet PC, laptop, desktop or other similar computing device. On a tablet or slate with a stylus, the defined forms may be filled via a paper-like user interface such as that defined by Advanced Digital Systems, Inc. In one example, a paper-like user interface may be defined to include a number of different fields and may or may not include storing and/or displaying all electronic ink associated with a “page” even if any part of the writing falls completely outside of a field. An example of suitable fields may include fields where writing may extend outside of the field but still be assigned to the field, fields for automatic handwriting recognition, and fields keeping and presenting all or part of the handwriting as electronic ink. Other examples of suitable fields may include fields for annotating photos, capturing signatures or for taking notes to be kept as electronic ink. In one example, one or more fields may give feedback to the user after written input that has the appearance of writing. One or more fields may allow corrections by writing over top of an incorrect result. And in another example, one or more fields may give feedback to the user after written input that is highlighting or other indication of a selection, or one or more fields may give feedback that is machine recognizable text.

B. Transforming a Form

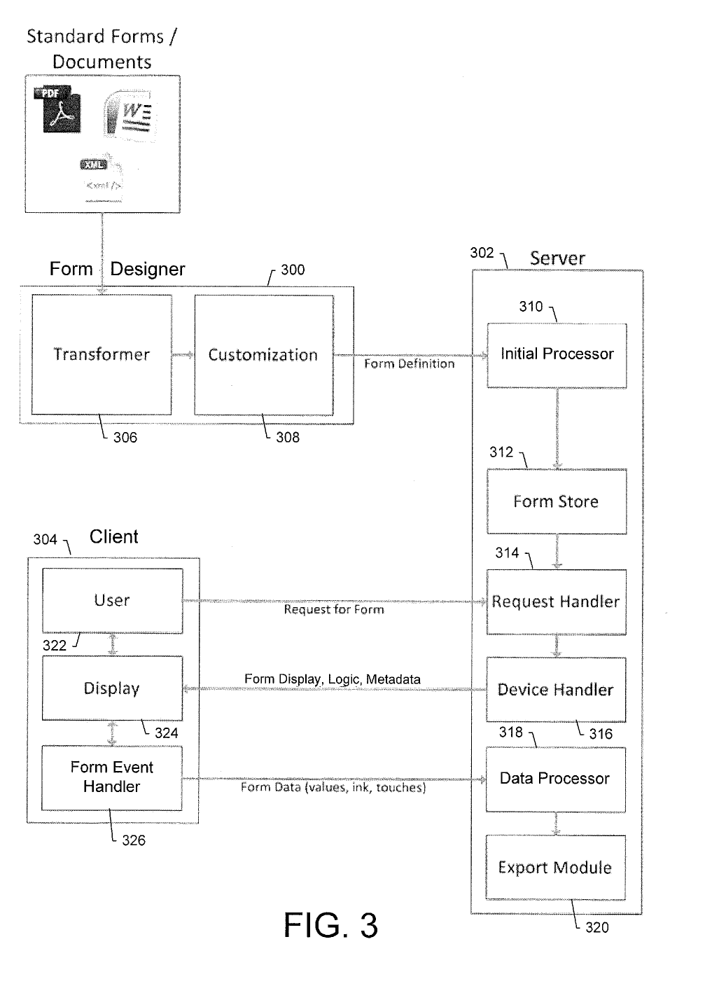

FIG. 3 illustrates a form designer 300, server 302 and client 304 that may be configured to operate as respective ones of form designer 100, server 102 and client 104, according to another aspect of example implementations of the present disclosure. As shown in FIG. 3, the form designer of one example may be configured to accept, receive or otherwise input a form definition in a standard format (sometimes referred to as a “standard form definition”), and automatically transform the form to a client-based format (sometimes referred to as a “client-based form definition”) for display and/or event processing on a client. The client, then, may process one or more events on the form to accept accurate and complete data into fields on the form. In one example, a form definition may specify a collection of field names, field types, field labels, field positional and size values constraints on field inputs, default values for fields, form logic and validation, and/or other non-field related meta-information.

A standard format for a form may be one generally accepted by and widely used by those skilled in the art. Examples of standard formats for form definitions include Microsoft Word documents and PDF files. In one example, these and other form definitions may be provided in XML format with a corresponding schema or Document Type Definition (DTD). The form designer 300, then, may include a transformer 306 configured to transform the form. In this regard, the transformer may be configured to read and interpret the standard format form and translate it to another, client-based format suited for rendering on a client 104 such as a mobile device. This may include automatically generating any program code necessary for the form to process events, which in one example may include execution of computer program code in response to user input or an internally generated notification. The form designer may also include a customizer 308 configured to allow a user to customize formatting and logic applied by the transformer.

Examples of suitable events for event processing include touch-based events, writing-based events or internally-generated notifications. In one example, touch-based events may correspond to a user's finger touch or stylus tap, such as on a form field or form field label, form text (other than form field label), logo or other picture or image, control or the like. A writing-based event of one example may correspond to a user's writing with their finger or stylus as if writing on paper, such as into or outside of a form field. And an example of a suitable internally-generated notification includes one form field causing another form field to change in response to a calculation, such as in an instance in which a field may be defined as a sum of multiple other fields.

The form designer 300 may be configured to deliver the transformed form to a client 304 directly or indirectly, such as via the server 302 configured to handle interaction between the form designer and one or more clients. In one example, the form designer may be configured to deliver the transformed form to the server, such as in a form definition format. The server may include an initial processor 310 configured to accept incoming form definitions and moves them to a form store 312, which may be configured to track available forms and make them available to other components of the server such as a request handler 314 and/or device handler 316. As also shown and explained below, the server may include a data processor 318 and/or export module 320.

The client 304 may include a user module 322 configured to handle user interactions with the client. In one example, user module may be configured to receive or initiate a request for a form with the server 302, which may be received and processed by its request handler 314. The request handler may be configured to handle the incoming request from the client and delivery of the requested form to the client. In one example, the request handler may be configured to interact with the device handler 316, which may be configured to customize logic, metadata, form display or the like based on the type of client, before delivery of the form to the client.

The client 304 may include a display 324 configured to implement a user interface in which the requested form may be displayed and completed by the user under at least partial control of one or more form event handlers 326. The event handlers may be configured to handle the event processing introduced above, and explained in greater detail below. The event handlers may also be configured to pass form data to the data processor 318 of the server 302, which data processor may be configured to handle incoming data. And in one example, the data processor may be configured to communicate with the export module 320 configured to export form data such as to user-defined back-end databases.

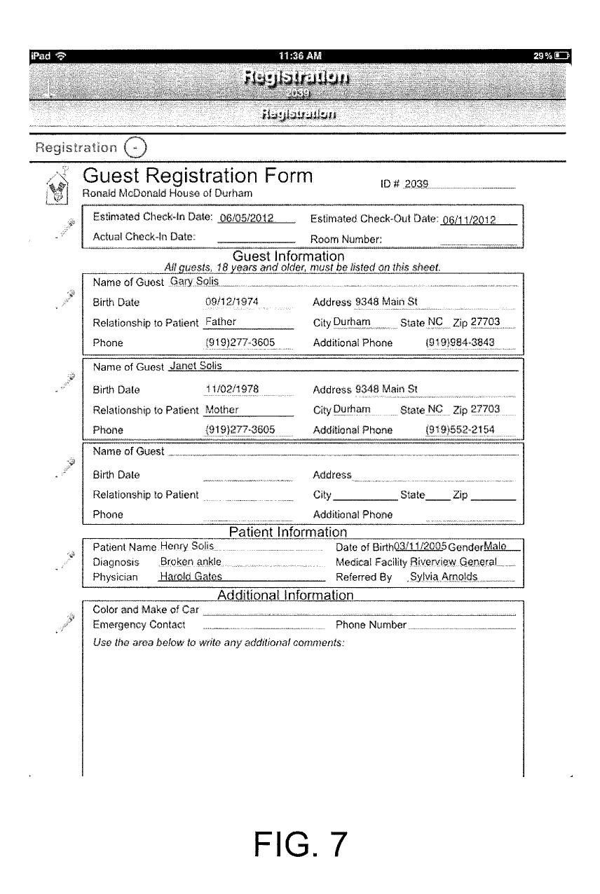

Again, the form designer 300 of one example implementation may be configured to transform a form for display and/or event processing on a client 304. There may be many ways to transform the form for display on the client. If the form on the client is to resemble as closely as possible the form in its standard format, the transformation may include scaling the positions of fields and/or other form elements to fit the display 324 of the client. FIG. 7 illustrates an example form on a mobile device that may resemble the form in its standard format. In another example, the transformation may include retrieving a list of field elements from the form definition, and their display in a single column along with any appropriate input areas on the client such as disclosed above.

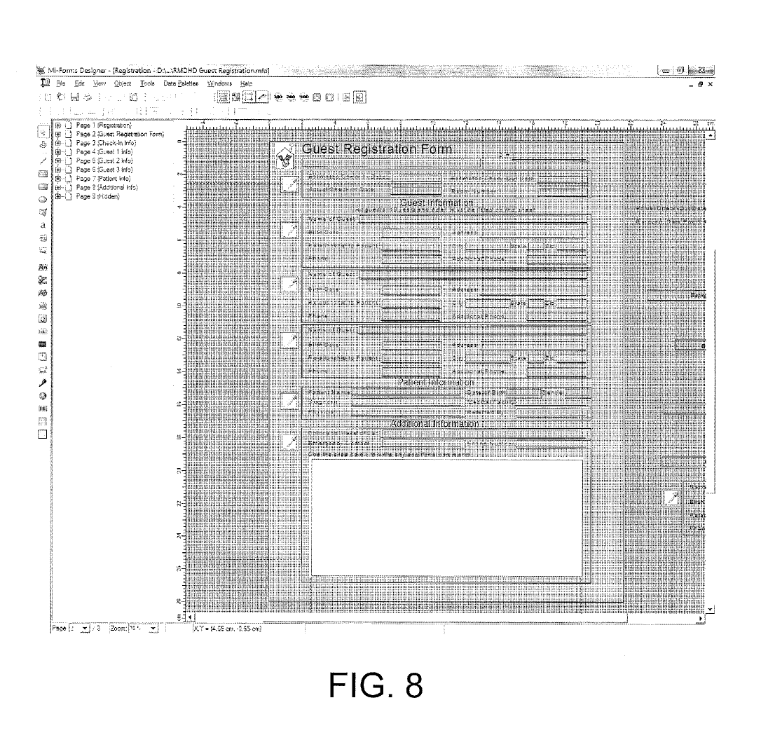

As indicated above, a client user may interact with the form on the client in a number of different manners to effectuate an event that may be processed according to example implementations. During the transformation of a form from its standard format to a client-based format, in one example, the field type may be ascertained for each field, such as directly from the standard form definition or by an image analysis algorithm, or it may be manually specified. If it is manually specified, a form design tool such as that illustrated in FIG. 8 may be used to delineate fields on the form and their form types. At execution time on a client 304, events may be evaluated as to their event type and to their targeted field, if any. Depending upon at least one of the field type or location of the event, a form event handler 326 may be applied to handle each event type. Standard clients may allow a software developer to specify form event handlers, which may be program code executed when events occur. In one example, events may be automatically detected by standard clients and handlers triggered. Similarly, in one example, code for form event handlers may be automatically generated.

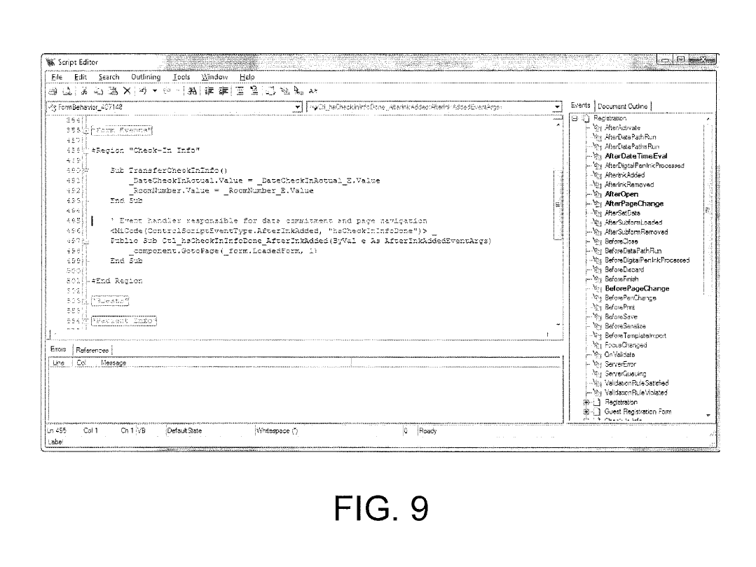

Each type of form event handler 326 may include pre-defined, automatically-generated program code that defines default interactive behavior of form fields without customization. During form transformation by the customizer 308 of the form designer 300, the pre-defined program code may be nullified or augmented by custom program code, which may be written by a form designer to achieve desired interactions when the user triggers the event during the execution of the form. Pre-defined and custom program code may be displayed and modified in the form design tool, as shown for example in FIG. 9.

In one example, if the user touches a form field label, automatically-generated code may display meta-information from the form definition describing what the field should contain. Optionally, automatically-generated code may call a function specially designated either by name, attribute or otherwise registered as corresponding to this event, which has been customized in a form design process. This custom function may bring-up lists enabling the performance of lookups or perform other functions.

In another example, if the user touches a form field, if the field is a text field, automatically-generated code may display a popup keyboard to allow the user to enter text into the field. Alternatively, if the field is a radio button or checkbox field, the automatically-generated code may register an option as selected. Optionally, automatically-generated code may call a function specifically designated either by name, attribute or otherwise registered as corresponding to this event, which has been customized in a form design process. For example, a field may be conditionally locked against input. The entered text or binary value of the checkbox may be the value of the field (where a single checkbox may be a field in this case).

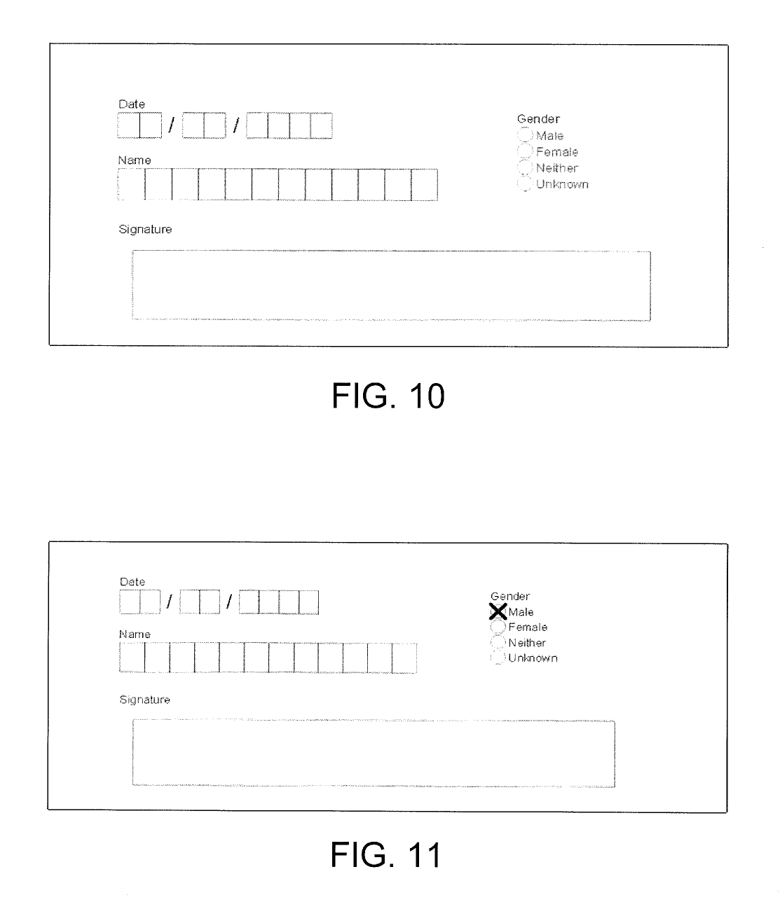

To further illustrate the aforementioned examples, FIGS. 10-13 illustrate example displays that may be presented during a sequence according to one example implementation. FIG. 10 illustrates an example of a form created using the form designer 300, with the illustrated form initially appearing blank and including highlighted fields to indicate a validation state (e.g., required field). As shown in FIG. 11, a single touch or tap on a checkbox field of the form may check the respective box and clear the highlight over the field to indicate the validation rule has been satisfied. As shown in FIG. 12, a single touch or tap on a text field (e.g., date field) may zoom the view such that the text-value entry area is now larger, centered and has focus. In this case, a textbox control is shown for keyboard (physical or virtual) data entry. And the background may be darkened to highlight the focus on the field for editing. After entering text into the field, a single touch or tap on the darkened background area around it may zoom back out to display a larger area of the form with the new value displayed for the text field, as shown in FIG. 13. As shown, then, the entered data will be displayed according to the form's layout.

In another example, if the user touches other text or a field, automatically-generated code may display the text and surrounding text in a larger font to give the appearance of zooming in on an area of the form (see, e.g., FIG. 12). Optionally, automatically-generated code may call a function specifically designated either by name, attribute or otherwise registered as corresponding to this event, which has been customized in a form design process. For example, touching certain text may trigger the display of a web page or other document, which has other information pertinent to the text.

In another example, if the user touches a logo, automatically-generated code may launch a browser to display a web site corresponding to the logo. Similarly, a field of the form may have associated with it a caption (in a pre-defined spatial area outside of the field) that if touched by the user, may cause automatically-generated code to launch a browser to display a web site corresponding to the respective field caption. Optionally, automatically-generated code may call a function specifically designated either by name, attribute or otherwise registered as corresponding to this event, which has been customized in a form design process. For example, meta-information may be displayed corresponding to the logo, describing the item represented by the logo.

In another example, if the user touches a picture or a field accepting a picture, automatically-generated code may display meta-information about the picture. Optionally, automatically-generated code may call a function specifically designated either by name, attribute or otherwise registered as corresponding to this event, which has been customized in a form design process. For example, the code may activate the camera of the device, allowing the user to take a new picture and replace the touched picture. The picture and meta-information may become the value of the field.

In another example, if the user touches a control, automatically-generated code may display, change, or accept input from the control. The input from the control may be stored as the value of the field. Optionally, automatically-generated code may call a function specifically designated either by name, attribute or otherwise registered as corresponding to this event, which has been customized in a form design process. For example, the values or options of a field such as a picklist may be determined by the values of other fields on the form.

In another example, if the user inks such as by writing with a stylus or finger in a form field, automatically-generated code may render an image of the writing in the field, may render text corresponding to automatic handwriting recognition results in the field, may render an image of the writing and keep recognized text in a data structure that is not displayed, or may render an indication that a checkbox selection has been made. The writing and/or text may be stored as the value of the field. Optionally, automatically-generated code may call a function specifically designated either by name, attribute or otherwise registered as corresponding to this event, which has been customized in a form design process. For example, custom code may copy the writing into a data structure for later copying into a database, report page or other storage or display mechanism.

And in yet another example, if the user inks such as by writing with a stylus or finger outside of any field, automatically-generated code may capture or record the writing such as without it being associated with any field, or the automatically-generated code may ignore the writing. Optionally, automatically-generated code may call a function specifically designated either by name, attribute or otherwise registered as corresponding to this event, which has been customized in a form design process. For example, writing outside of any field may trigger an email containing an image of the form or other text. Any or all of the writing may be stored for later use.

There are several ways a new field could be added by interacting with a portion of the form outside of any field. In one example, if the user has just previously activated a control or hot spot (e.g., a reserved area of the form) corresponding to a particular field type, program code may add a field of that type to the form, such as by changing the user interface and adding a field of that type to a data structure representing the form. In another example, automatically-generated code may display a dialog box or other window that allows configuration of a new field or fields and its properties, which program code may then display in the user interface when the dialog box is dismissed. In yet another example, interaction with a hot spot may cause program code to reveal previously-hidden fields.

In another example, if the user interacts with a portion of the form outside of any field, program code may add an interface layer over a portion of the form. This interface layer may include, for example, a borderless window or dialog that takes the appearance of a “sticky note” to accept handwriting, typed text, photos or other input. Such an interface layer may at times be referred to as a desktop note, although without loss of generality to applications outside of a desktop computing environment.

In some examples, one or more fields may each include context information with information regarding the respective fields. This information may be textual, but may additionally or alternatively include video and/or audio information. In these examples, if the user interacts with a caption for such a field, program code may display or play the context information for the respective field.

In a similar example, if the user interacts with the caption of a field, or other pre-defined spatial area outside of any input field, program code may play or display context information, or display validation information, for the respective field, the fields or the form, such as in separate borderless window or dialog. In various instances, the program code may display a message in a colored background that may vary from green (no validation errors), to yellow (non-critical validation errors), to red (critical validation errors). In the examples above, it is arbitrary which part of the form event handler 326 is default (automatically generated or included) and which part is custom behavior (specified at form design time). The above examples are for illustrative purposes only.

Relative to the client 304 being configured to accept accurate and complete data into fields on the form, during the form execution process, field values may be set when the user triggers events that constitute data entry for a field. Events may be filtered by the pre-defined event handler program code or customized event handler program code to ensure quality data entry. As determined during transformation of the form by the transformer 306 of the form designer 300, each field may be created in the client-based form definition with a specific field type. Field types may limit the type of acceptable values that may be entered by the user. During form transformation, business rule requirements may be ascertained from the standard form definition or entered by the form designer. During form execution at the client, then, the status of each business rule requirement may be evaluated for consistency and completeness of the data, and the results of each rule may be displayed to the user. As described above, values of fields may be set in the form event handler 326. A business rule evaluation function may be called after every custom behavior section in the functions that handle events.

In various examples, there may be form elements that do not come from the standard form definition, but that may be useful on the client 304. For example, an edit icon corresponding to a group of fields may be added. The group of fields may be defined by a lookup table based on their location on the form and/or proximity to other fields, or by inclusion in a bounding box explicitly included on the form. If the edit icon is triggered such as by touch, a new screen may be shown displaying only the fields in the group for editing or reporting.

To further illustrate example implementations of the present disclosure, consider an example in which a standard form definition may be transformed to a client-based form definition including a form representation in one or more Scalar Vector Graphics (SVG) format elements in combination with other form definition elements. Each SVG element may be an XML-based format for representing two-dimensional graphics that may represent the entirety of a form page or a specific subset thereof.

During form definition or execution, the collection of fields in the client-based form definition may be associated with positional target areas on the SVG displayed to the user. User actions and internally generated notifications may trigger event handlers for fields which in turn may redefine the SVG contents, changing the appearance of the form or its fields.

The SVG element may itself contain program code. This program code may act as one or more form event handlers 326.

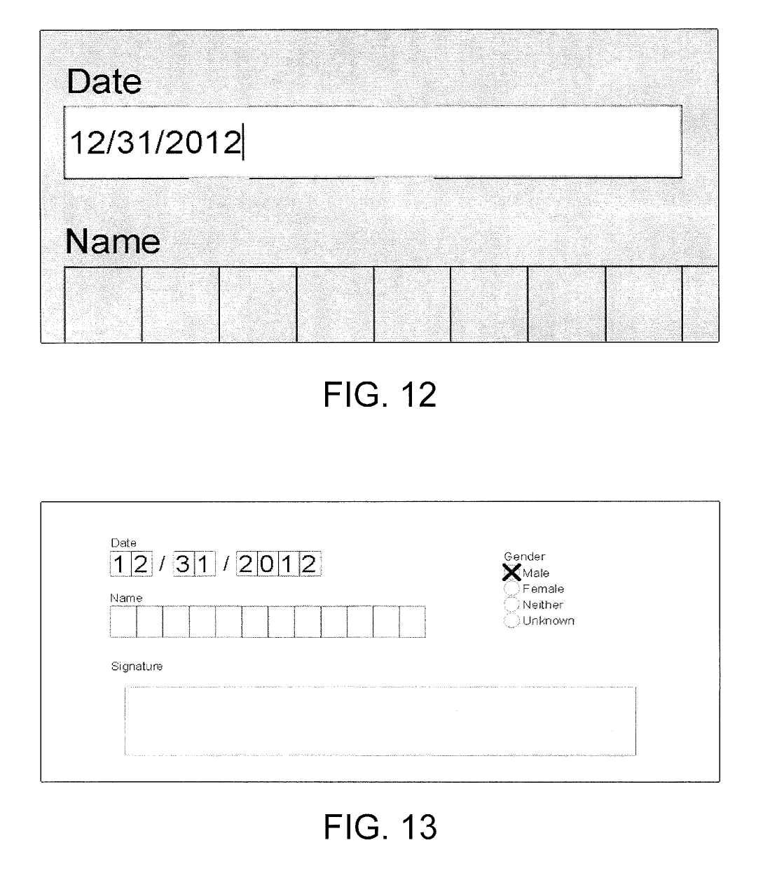

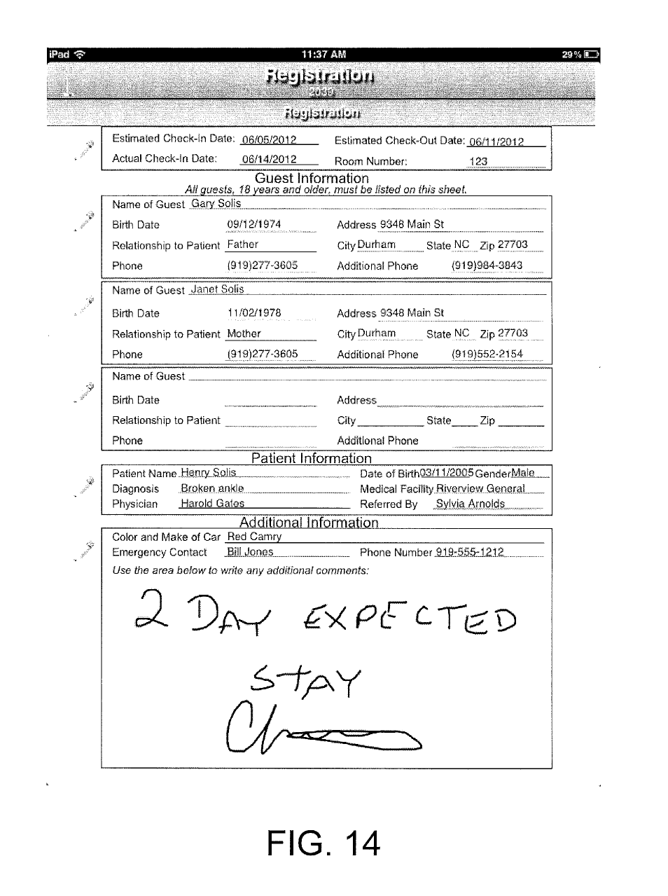

For a field type that accepts writing, an SVG path element may be added to the SVG element. This path element may define color, thickness and/or transparency level of the ink corresponding to the writing, and may appear to the user as an ink stroke that follows the path of the writing. This ink may be modified by an event handler 326 associated with the inking event either automatically generated or through the execution of an associated event handler function. As an example, such a function may modify the appearance of the ink (e.g., color, thickness, location) or process it in such a way as to create discrete data values either in this field or in others based upon ink characteristics. An example of a suitable field is shown at the bottom of FIG. 14.

For a field type that accepts text entry, touching the field may present another user interface control that is conducive to accepting text. For example, the user interface implemented by the display 324 may present a virtual keyboard directly in line with the SVG element such that when keys are touched, text may be immediately displayed in the field. Alternatively, the user may be shown a dedicated input display that increases the ability to enter valid data such as through the use of predicative input models.

For a field type that accepts direct input such as a checkbox, radio button or drop down list, the user interface may process the event in such a way as to directly modify its display. In the case of a checkbox or radio button, for example, the SVG element may have a checkmark added to it or other visual symbol indicating the field's current value (see, e.g., FIGS. 11, 13). In the case of a drop down list, for example, a modal dialog may appear displaying possible options and upon user selection the value may be displayed directly on the SVG element.

For one example of a field type that accepts touch input and contains customized or automatically-generated event handler program code, such as a “button” or “hotspot” field type, a touch event may provide page changes, display of more information such as form filling instructions, or other similar functions. In each case, the specifics of the user interface change may be automatically generated in the event handler 326 (e.g., page navigation) or by presenting new user interface elements to the user in a customized event handler (e.g., a modal dialog with form filling instructions).

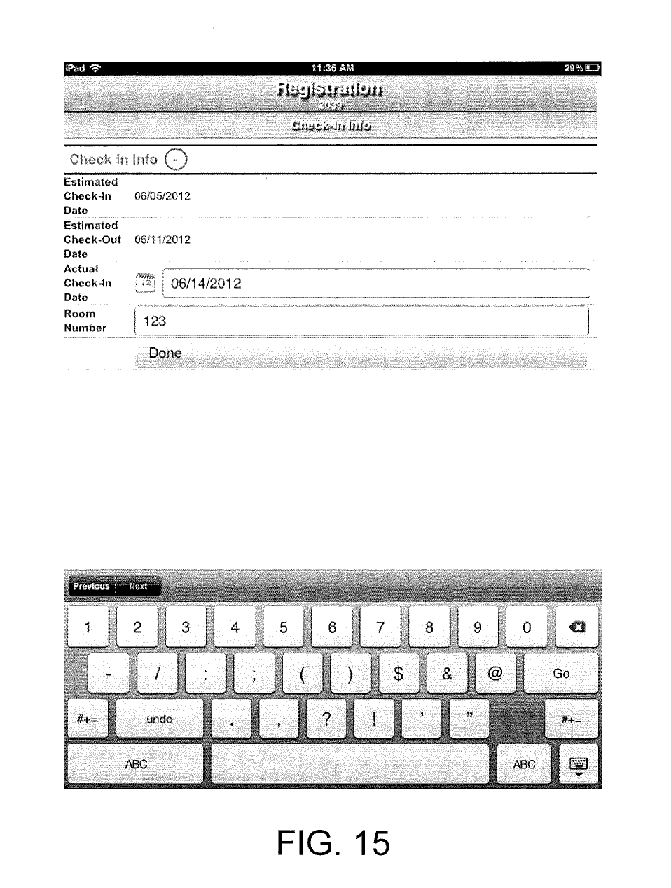

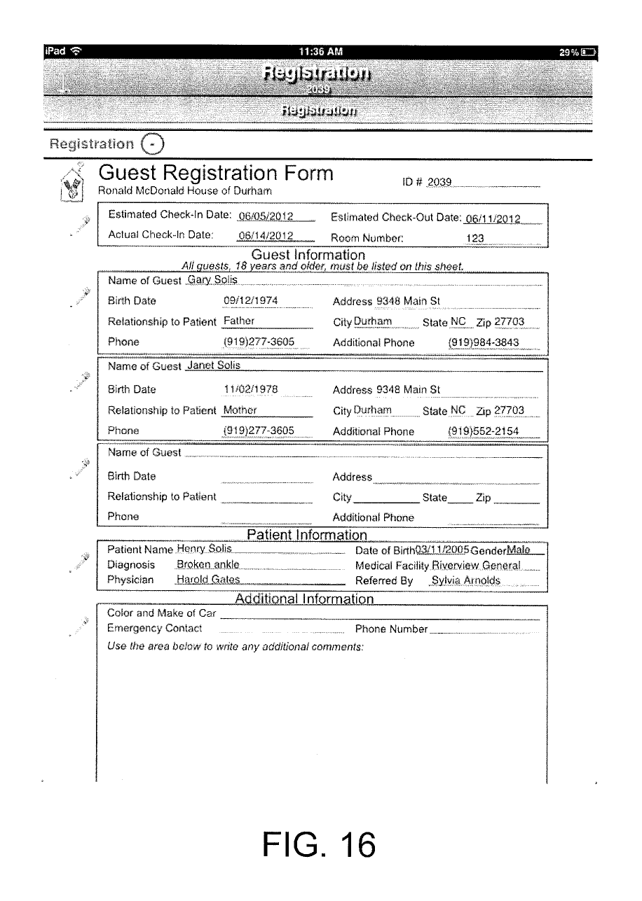

In one example, fields may be logically grouped together. If a field group is touched, the display may change so that data may be entered in the fields in the group using the standard input controls of the client 304, and the fields may be arranged in a column as in FIG. 15, for example. After the group of fields is edited using standard means, the form resembling the original standard format may be updated to contain the newly entered data or data pre-populating the form from a database or other source as in FIG. 16, for example.

C. Interacting with an Electronic Form

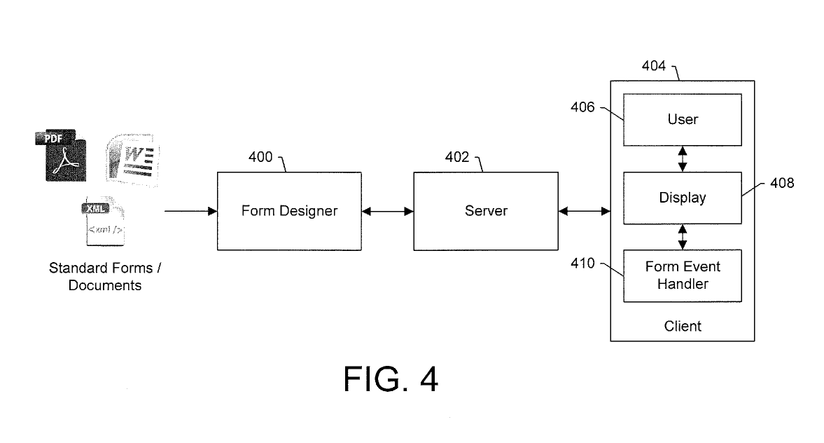

FIG. 4 more illustrates a form designer 400, server 402 and client 404 that may be configured to operate as respective ones of form designer 100, server 102 and client 104, according to yet another aspect of example implementations of the present disclosure. As shown in FIG. 4, the form designer of one example may be configured to accept, receive or otherwise input a form definition. In one example, the form definition may be accepted, received or otherwise input in a standard format (sometimes referred to as a “standard form definition”), and the form designer may be configured to automatically transform the form to a client-based format (sometimes referred to as a “client-based form definition”) for display and/or event processing on a client. The client may be configured to process one or more events on the form to accept accurate and complete data into fields on the form. In one example, a form definition may specify a collection of field names, field types, field labels, field positional and size values constraints on field inputs, default values for fields, form logic and validation, and/or other non-field related meta-information.

Examples of suitable events for event processing include touch-based events, writing-based events or internally-generated notifications. In one example, touch-based events may correspond to a user's finger touch or stylus tap, such as on a form field or form field label, form text (other than form field label), logo or other picture or image, control or the like. A writing-based event of one example may correspond to a user's writing with their finger or stylus as if writing on paper, such as into or outside of a form field. And an example of a suitable internally-generated notification includes one form field causing another form field to change in response to a calculation, such as in an instance in which a field may be defined as a sum of multiple other fields.

The form designer 400 may be configured to deliver the transformed form to a client 404 directly or indirectly, such as via the server 402 configured to handle interaction between the form designer and one or more clients. The client may include a user module 406 configured to handle user interactions with the client. In one example, the user module may be configured to receive or initiate a request for a form with the server.

The client 404 may include a display 408 configured to implement a user interface in which the requested form may be displayed and completed by the user under at least partial control of one or more form event handlers 410. The event handlers may be configured to handle the event processing introduced above, and explained in greater detail below. The event handlers may also be configured to pass form data to the server 402, which may be configured to handle incoming data. And in one example, the server may be configured to export form data such as to user-defined back-end databases.

As indicated above, a client user may interact with the form on the client in a number of different manners to effectuate an event that may be processed according to example implementations. In one example, a form event handler 426 may be applied to handle each event type. Standard clients may allow a software developer to specify form event handlers, which may be program code executed when events occur. In one example, events may be automatically detected by standard clients and handlers triggered. Similarly, in one example, code for form event handlers may be automatically generated.

Each type of form event handler 426 may include program code that defines interactive behavior of form fields, and which code may include either or both pre-defined, automatically-generated code or custom program code. In one example, if the user touches a form field label, automatically-generated code may display meta-information from the form definition describing what the field should contain. Optionally, automatically-generated code may call a function specially designated either by name, attribute or otherwise registered as corresponding to this event, which has been customized in a form design process. This custom function may bring-up lists enabling the performance of lookups or perform other functions.

In another example, if the user touches a form field, if the field is a text field, automatically-generated code may display a popup keyboard to allow the user to enter text into the field. Alternatively, if the field is a radio button or checkbox field, the automatically-generated code may register an option as selected. Optionally, automatically-generated code may call a function specifically designated either by name, attribute or otherwise registered as corresponding to this event, which has been customized in a form design process. For example, a field may be conditionally locked against input. The entered text or binary value of the checkbox may be the value of the field (where a single checkbox may be a field in this case).

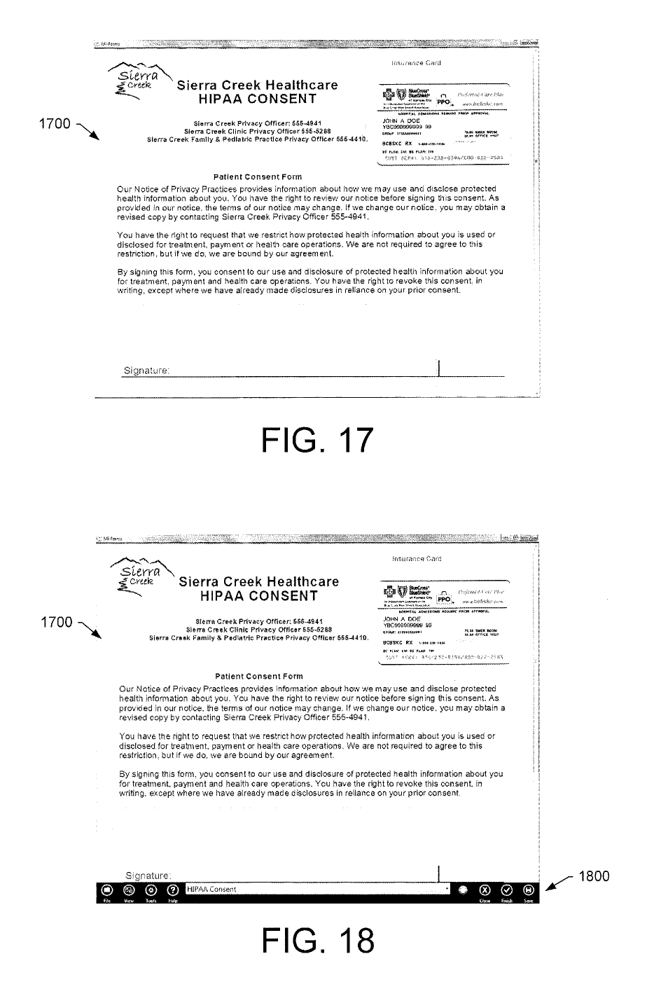

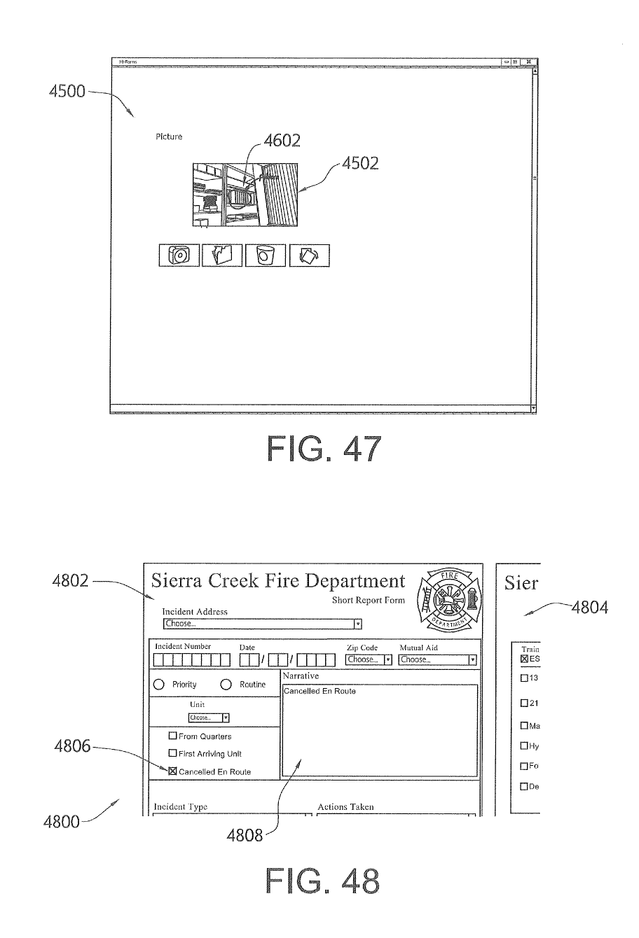

The client and its components may support any of a number of features and functions to facilitate user interaction with one or more electronic forms. Examples of these features and functions include those related to menus, validations, page navigation, page navigation with contextual touch, contextual touch, contextual-touch menu, field-edit mode change, cursor placement in constrained text fields, image annotation and script response processing. Each of these example features and functions are described below with reference to example displays shown in FIGS. 17-48.

1. Menu Display

In accordance with example implementations, one or more menus, lists or the like may be displayed in an animated fashion when the mouse or stylus is hovered over the appropriate area. These menus, lists or the like may be displayed in response to hovering such as with the stylus, and may be independent on either touch gesture or right-click.

Many applications have a menu bar and other toolbars across the top or bottom that utilizes screen real estate. In general, the usage of these controls is limited to when the user needs to take some sort of special action (e.g., open, close, or save a document). Typically in usage, this might occur 10% or less of the time. In one example, interaction with a form may revolve around full page form filling, in which case it may be more appropriate to utilize this screen real estate elsewise. FIG. 17 illustrates an example display of a form 1700 that may represent a base view with no visible menus, toolbars, etc.

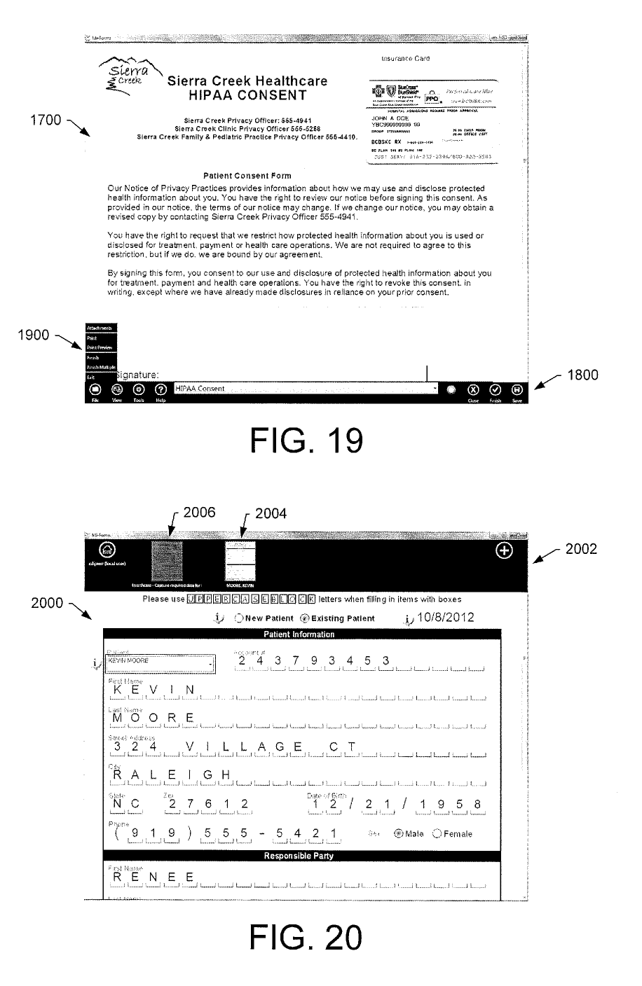

However, a menu may need to be accessible to the user when necessary. Example implementations may use a mouse or stylus hover over the bottom portion of the window to access the menus. FIG. 18 illustrates an example display that includes a menu 1800 in the displayed state, which may be presented using some form of animation. In order to further maximize screen real estate, the number of items on this menu may be kept rather small. This may necessitate expansion of a given menu, which may be accomplished by hovering the stylus or mouse over one of the icons. This is shown in FIG. 19 in which such a hovering may cause expansion of the menu to include a sub-menu 1900. As shown in FIG. 19, the items on the right side of the menu (e.g., “Close”, “Finish” and “Save”) may be reserved for common tasks and may not require a hover, as directly clicking or touching them may allow the user to take an action.

In similar fashion, FIG. 20 illustrates an example display in which a multi-page form has been opened, and a page 2000 of the form is presented. Now for the user to navigate between multiple open forms, a list of forms 2002 represented as thumbnails may be brought into view such as by being dropped down from the top of the screen upon hover with the stylus or mouse. This specific example shows two open forms. The thumbnail for the currently-active form 2004 is highlighted, while the other form 2006 is shown with a grayed out transparency. Borders around the thumbnails may indicate validation status, as discussed below. It should also be noted that common form switching tasks of opening another form (+), and returning to a home splash screen (house icon), may be provided using simple icons.

2. Validation Display

In various examples, there may be at least one of a left, a right, a top and/or bottom colored border that varies depending on the presence or absence of any validation errors. For example, the border may vary from green (no validation errors), to yellow (non-critical validation errors), to red (critical validation errors). This may provide a quick user interface cue such as in a manner similar to field highlighting. Additionally or alternatively, a validation status indicator may be provided on a menu that's both color and shape based for the purposes of compliance.

In form filling, the concept of form validations may be a key component. These can be as simple as a required field or checking field consistency or as complex as requiring database lookups based on specific data entry. No matter the specifications of the rule, however, forms may be thought of as having either no validation errors, critical validation errors that prevent submission, or non-critical errors that act as warnings or guidelines. As one may expect, using colors such as green, red and yellow work well for these three states. However, as noted before, example implementations may not have a toolbar in which to display this status to the current form filler. Instead, example implementations may include border and/or other visual cues.

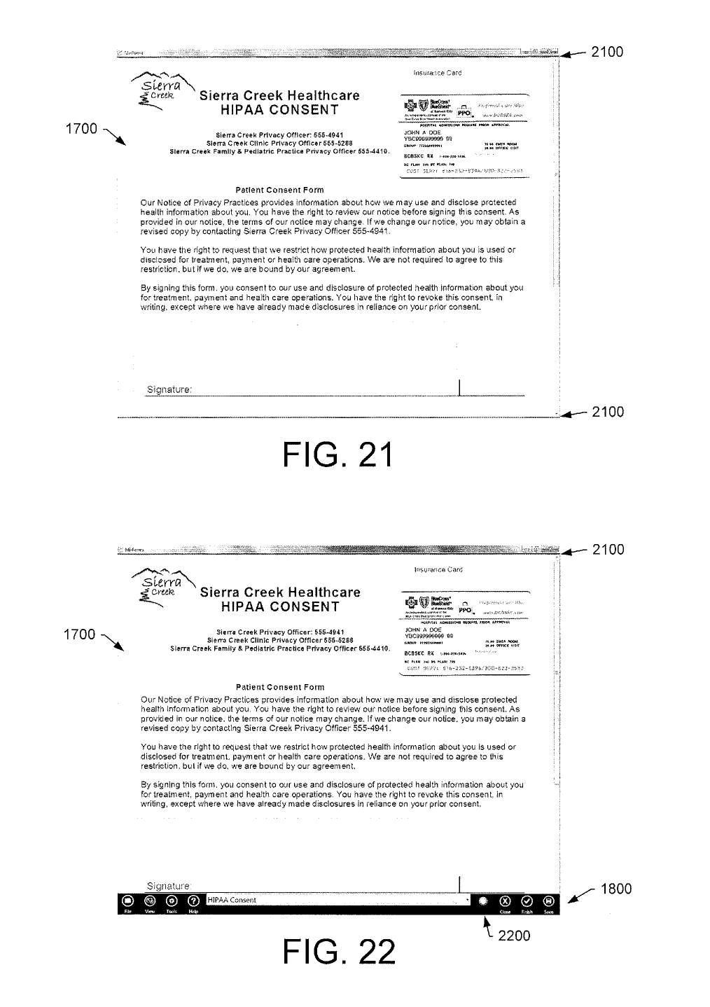

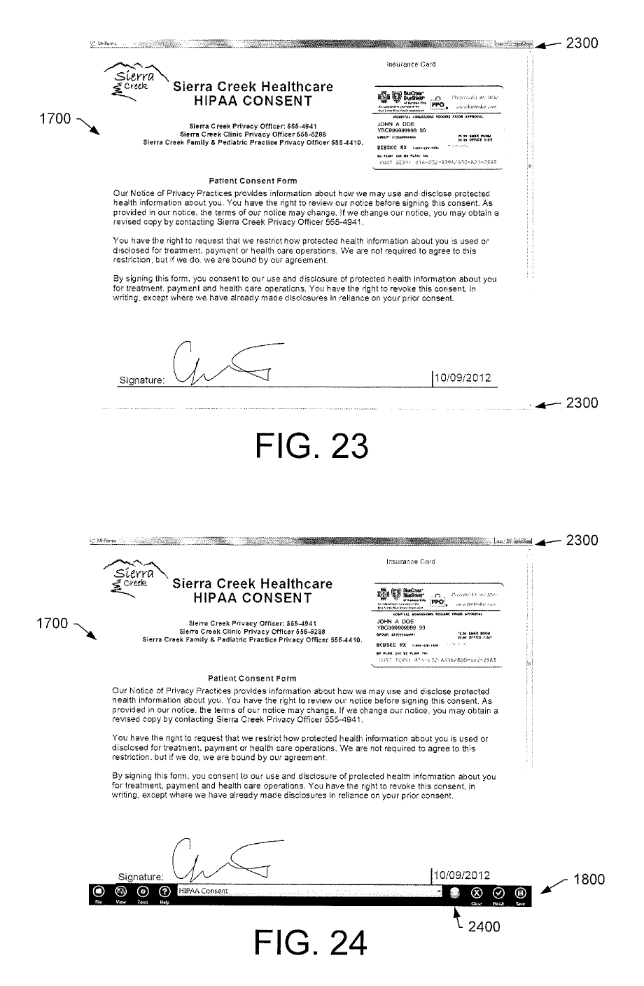

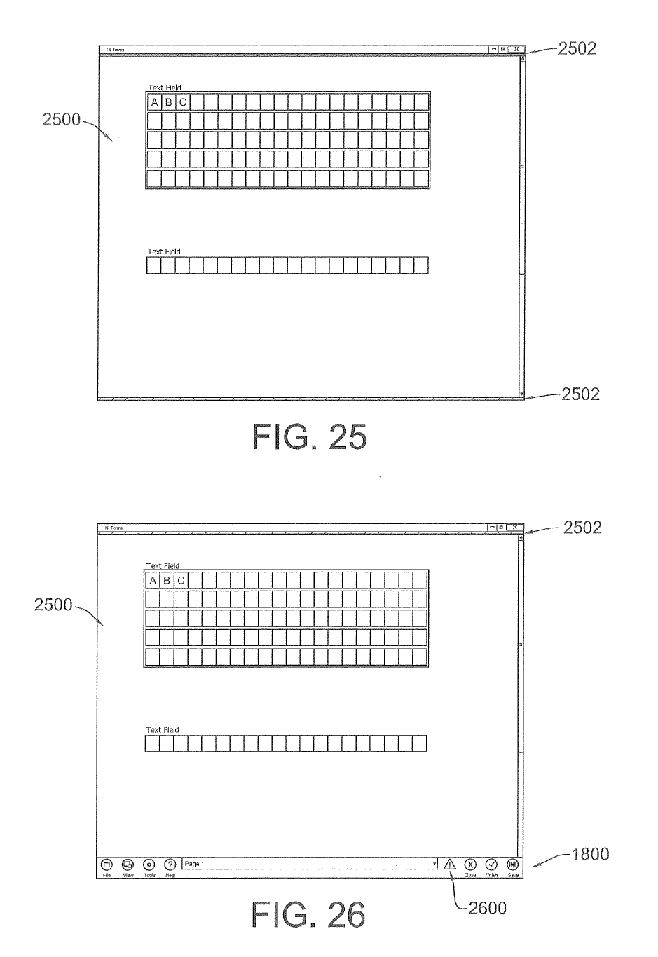

FIG. 21 illustrates an example display in which form 1700 includes critical validation rule errors, where a red border 2100 may be displayed at the top and bottom (although the border may be on other sides, or a fewer or greater number of sides). Additionally, as shown in FIG. 22, expanding the bottom menu 1800 provides both a color and shape cue to the current validation status of the form, which as shown may be presented as a red stop sign type of icon 2200. Then, as shown in FIGS. 23 and 24, a form 1700 that has its validation rules satisfied, the red border 2100 may be replaced with a green border 2300, and similarly, the red icon 2200 may be replaced with a green shape cue 2400. As shown for another form in FIGS. 25 and 26, for a form 2500 that only has non-critical errors, a yellow border 2502 is used and a yield shaped icon 2600 may be displayed.

3. Page Navigation

Many if not most other form-filling applications have some sort of page previous/next button. Example implementations of the present disclosure may do away with this in order to save screen real estate. Instead, example implementations may use previous/next bars that may only appear when one hovers with the stylus over a side of the form, or touches or taps the side of the form, such as over the left or right area of the form. When these bars appear, they may quickly resize the form smaller so the filler can still see the contents of the current form page and then they disappear after use. For touch input, swipe gestures may be used to change pages as well.

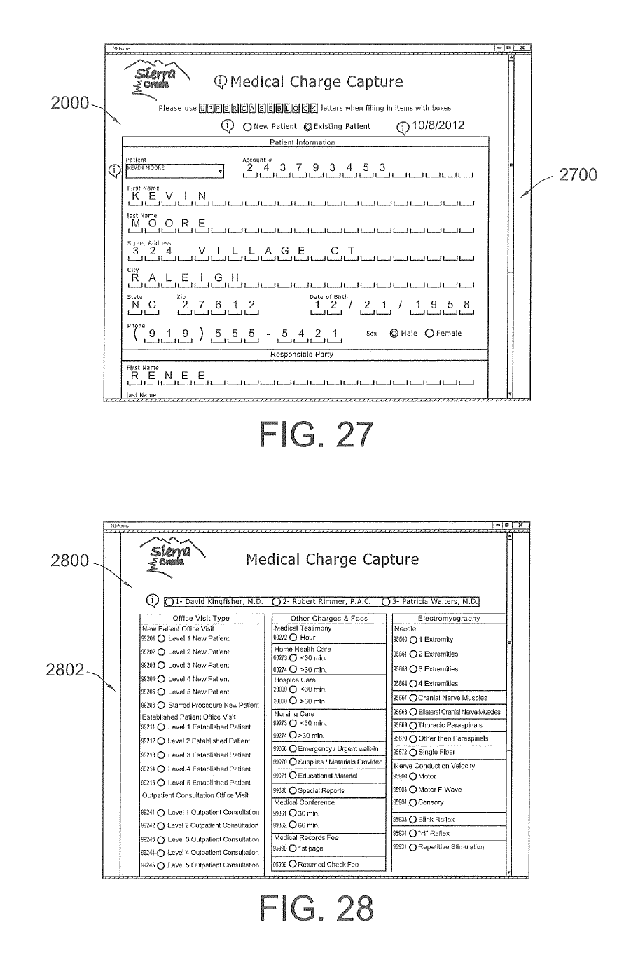

FIGS. 27 and 28 illustrate the multi-page form of FIG. 20, in which one page 2000 is presented in FIG. 27 and another page 2800 is presented in FIG. 28. As shown in FIG. 27, a page of a multi-page form may be displayed without previous or next page buttons displayed by default. This saves screen real estate again. However, in a form where there is a page subsequent to the current page, hovering the stylus or mouse over the right side 2700 of the form, or touching or tapping the right side of the form, may display a bar (with highlighting when further hovered) allowing for a tap, touch or click to change to the next page. In similar fashion, as shown in FIG. 28, when there is a previous page 2000, the same type of control may be displayed when the stylus or mouse hovers to the left side 2802 of the form, or the left side of the form is touched or tapped. As noted, the form may not at all be obscured by these page-changing buttons, but may instead be resized temporarily allowing the user to see the entirety of the current form page while making page change decisions.

4. Page Navigation with Contextual Touch

For forms with multiple pages, the layout of the pages may be calculated and optimized by the amount of screen space available and the dimensions of each form page. On tablet devices, screens are viewed either in portrait or landscape modes and so the layout of form pages in each of these modes will change to ideally fit each form page. For example, an eight page form in landscape mode might display pages in a four column by two row matrix. While in portrait mode, the layout changes to a three column by three row matrix (where the last column and row intersection area is empty).

According to example implementations, depending on the “zoom-level” (field, page, or form level), each may contain applicable menus, buttons, labels, and such that are appropriate for the zoom level. For instance, while at the form-level, the form menu at the top may appear. When at the page or field zoom level, the form menu may be removed from view to maximize screen space for a page or field. While zoomed into a field, more field information (such as specific instructions) or field controls (for instance, a field that contains a complex set of user controls—e.g., a modifiable spreadsheet interface) may be displayed.

When pages are navigated, a quick, semi-transparent view of page number (and name) may be displayed as the page is navigated. This, again, may help to see where a user is in a form filling workflow. This may be done in a transparent way directly on the form page itself rather than in a drop-down list.

In one example, page navigation may be effected by tapping in a blank area around the pages to see all of the pages at once (or as many as fit) and then tapping a page to zoom into it. This may allow for quick page navigation in an easy to use way.

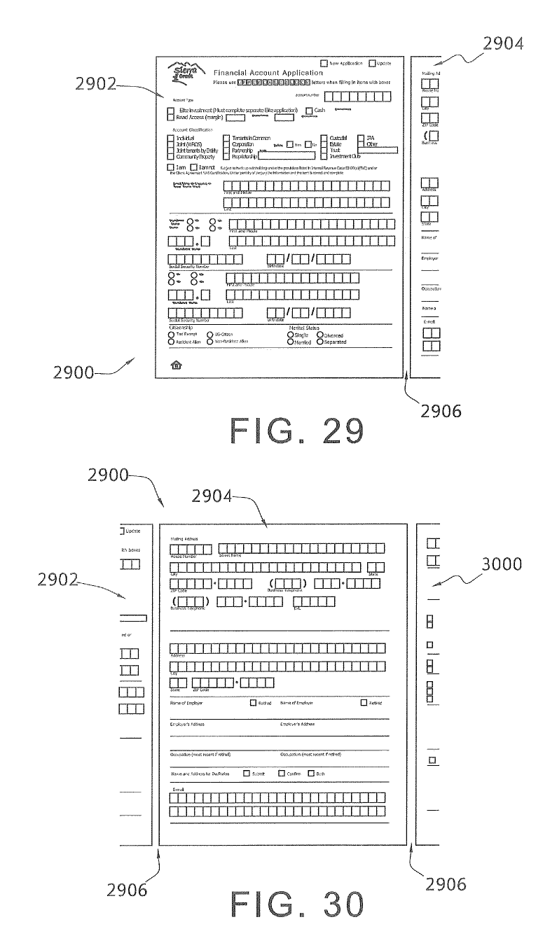

FIGS. 29-35 illustrate another multi-page (four page) form 2900 according to one example implementation. FIG. 29 illustrates the first page 2902 in which the entirety of the page is displayed with form controls and relevant data, labels, etc. All form controls on the first page may be active as the first page is currently “in focus.” The example also displays the left-most part of the second page 2904 that is partly displayed on the right side. All controls on the second page may be currently inactive as the second page is not active.

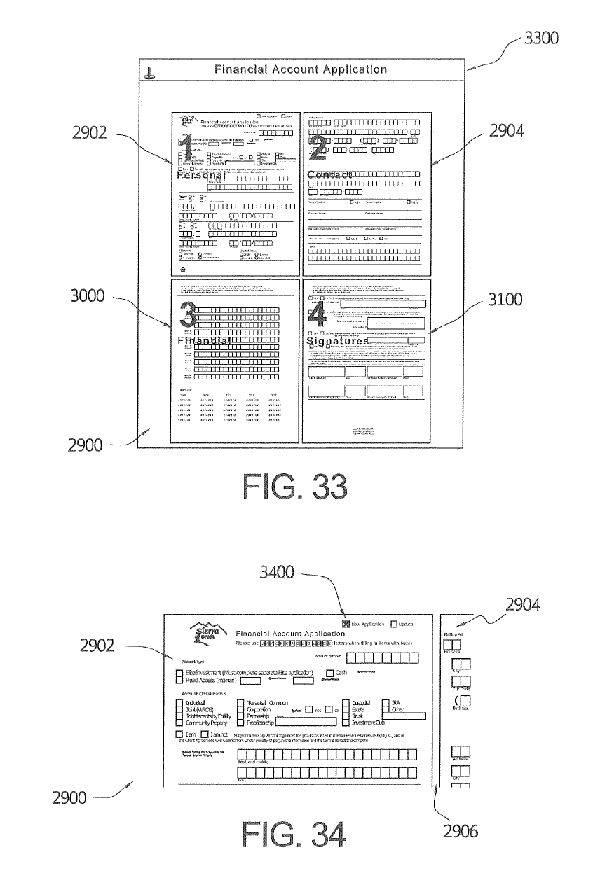

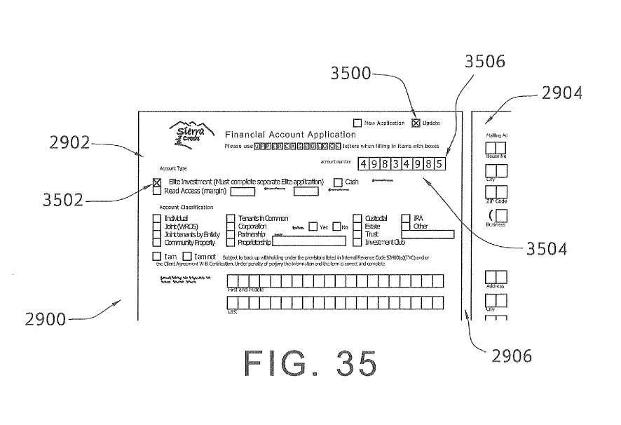

A touch on the screen may perform different contextual actions, depending upon where the touch is registered and if the page is in focus. For example, a touch anywhere in the blue area 2906 between pages and surrounding pages will zoom out to the form level and display all form pages in a grid, as shown in FIG. 33. In another example, a touch on any form control within a page may register as either data entry such as in the case of a checkbox (see, e.g., FIG. 34), or a user-initiated intention to focus upon a data entry field such as a text field, image carousel, or data table where further data entry may be needed to change the value of the field (see, e.g., FIG. 35). In yet another example, a touch on any page other than the active page may register as a user-initiated intention to change pages, where the touched page may slide into view and get focus, as shown in FIG. 30 for the second page 2904. It should be noted that there may not be any interfaces at the “page level” for performing a form type action (such as close form, save form or finish form); but in the more general case, there could be.

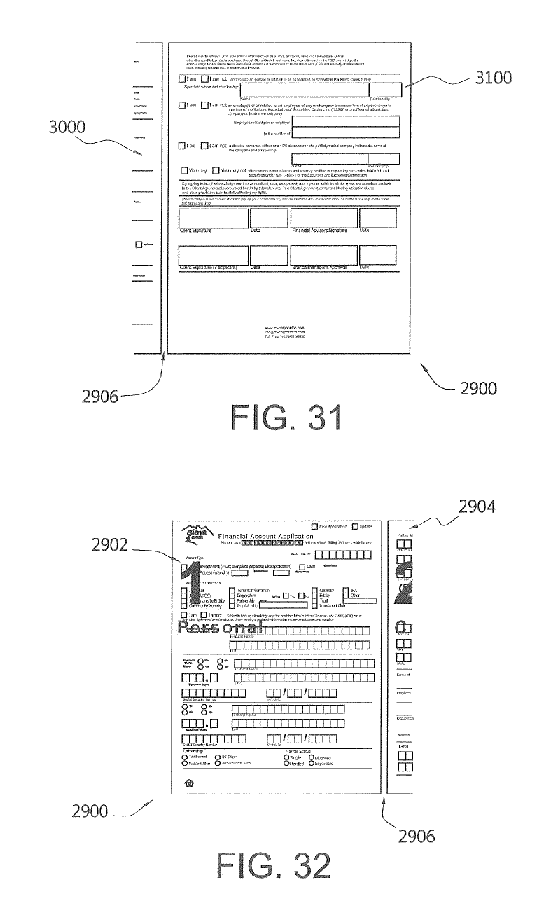

In other examples, while on a page that is not the first and not the last, partial views of the previous and next pages may be displayed on the left and right, which may be provided for page navigation when touched. This may be seen in FIG. 30 for the first page 2902 and third page 3000 on either side of the second page 2904. FIG. 31 illustrates the last page 3100 (here page 4) being in focus, with a partial view of the third page 3000 being displayed on the left of the last page, without a further page being displayed on the right.

As shown in FIG. 32, during a transition between pages, the page number and page name may be briefly displayed and faded out to provide the user with a brief glimpse of context information.

As shown in FIG. 33, when the entire form is displayed, page numbers and names may be displayed, until the user taps a page for navigation. At the form level, a number of form-level type actions are accessible. These actions may include a view of all form pages with labels, display of form name and other form level information (form description, business rule status, server connection status) on a menu 3300 at top, and a menu to access other form level actions such as close form or finish form, or the like.

5. Contextual Touch

When a user fills a text field, the user may tap on it causing it to auto-zoom to a proper size, and in various examples, the zoom level may be determined based upon a number of factors such as screen real estate, form size, virtual keyboard need, field size, others need or the like. As shown in FIGS. 34 and 35, a touch registered on a checkbox 3400, 3500, 3502 may check the box (and uncheck other associated boxes if the checkbox field was designed to accept only one value), or uncheck the box if it was already checked.

As shown in FIG. 35, when a text field 3504 is touched while the page is in focus, the text field may gain focus by visually “zooming into the field.” The amount of zoom (keep zoom at page level, zoom into the width of the page, zoom into the width of the actual field, zoom into the text field box that is currently the cursor for data entry) may be optimized for the device screen characteristics (such as size and resolution), actual width of the field, availability of a virtual keyboard or the like. In FIG. 35, the text field demonstrates a zoom to the page width. Also, while a text field is focused, the box for current data entry acceptance may provide a visual indication of this state such as by continually fading in and out or any other applicable cursor. In FIG. 35, the last box 3506 may display the faded visual.

While a field is in focus, a touch on certain areas of the screen may initiate various actions. For example, a touch on any other box in the focused field may set focus upon that box to accept more data entry. In another example, a touch on any other field on the current page may either change the value of the field or set focus upon the field, depending upon how the field type registered touches while not in focus. In another example, a touch on the focused page, but not in range of any field, may “zoom-out” to display the full page. And in yet another example, a touch on any non-focused page (e.g., page 2904), such as on a field or not on a field of that page, may navigate to that page.

6. Touch Context Menu

Many touch-supporting applications have a limited number of functions that may be directed by touch, such as panning, zooming, and page changing. However, there are times when a user may need his finger to do something different (e.g., inking) depending on context. Example implementations of the present disclosure may therefore provide a context menu such that if one taps and holds for a limited time (e.g., one second), it may change what functions the user's touch subsequently directs. This same context menu may additionally or alternatively come up from right clicking, but the menu may be customized based on input device (finger versus mouse versus stylus).

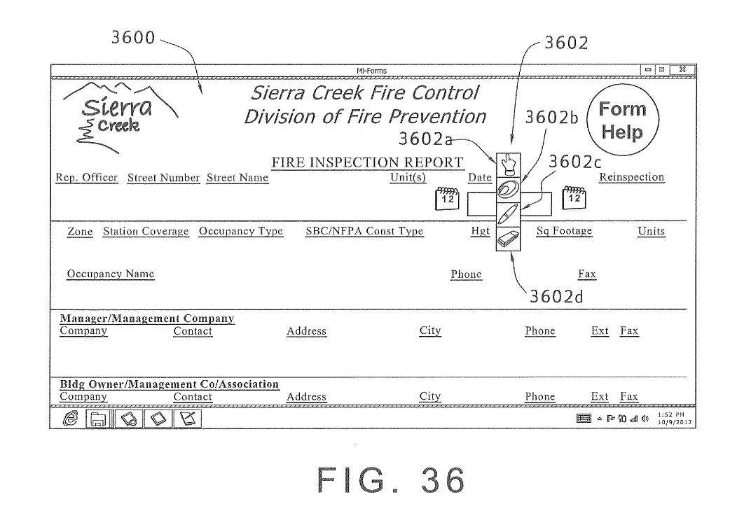

FIG. 36 illustrates an example display of a form 3600 according to one example implementation of the present disclosure. While using a form via touch, it may sometimes be necessary for a user to change what their touch gestures do. Since it may be undesirable to require the user to use a different input methodology, example implementations may allow the user to tap and hold for a limited time (e.g., one second). When this happens, a context menu 3602 may be displayed, as shown in FIG. 36.

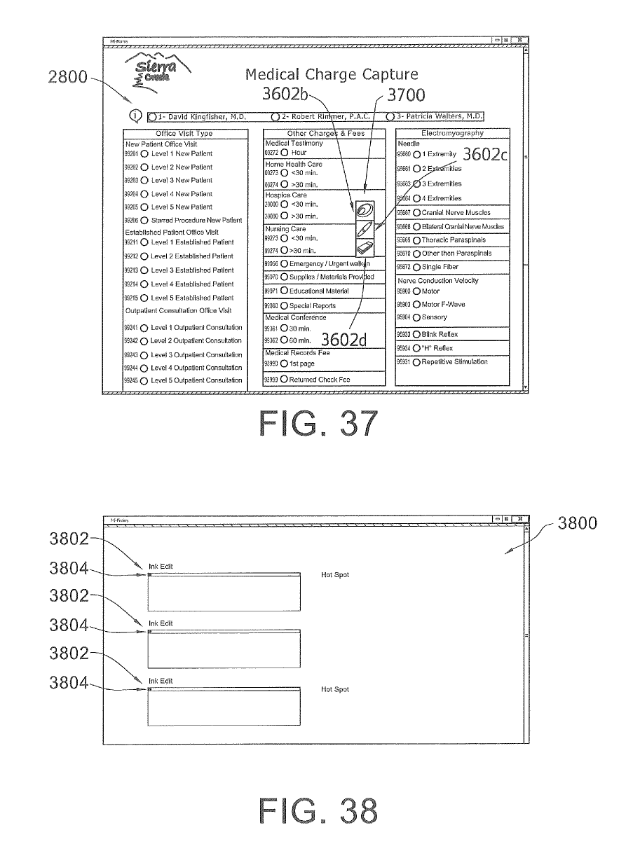

As shown, the touch modes may be represented by respective icons and may include gesture 3600a that allows for standard pinch to zoom, panning, etc., mouse 3600b that allows focus to be set to a form field, pen 3600c that allows for inking on the form and allows the color of the pen to be changed, and eraser 3600d that allows for removal of ink and data from the form. In the same way, as shown in FIG. 37 for the page 2000 shown in FIG. 20, if a user right clicks either with a stylus or a mouse, a similar context menu 3700 may be displayed, but may be tailored to their input device. Here the finger icon may in some implementations be removed because touch gestures do not necessarily apply to a stylus or mouse input.

7. Field-Edit Mode Change

Some example implementations may provide a way to quickly change between modes such as from inking mode to keyboard-entry mode, and vice versa. This may be accomplished by allowing hover with a stylus or mouse over a section of the control, which may make it easy to swap between entry (inking) and a different convenient edit mode (keyboard). FIGS. 38-40 illustrate an example display of a form 3800 according to one example implementation of the present disclosure. As shown, the form includes three ink-edit controls 3802 (controls that may be inked in for immediate recognition or typed in).

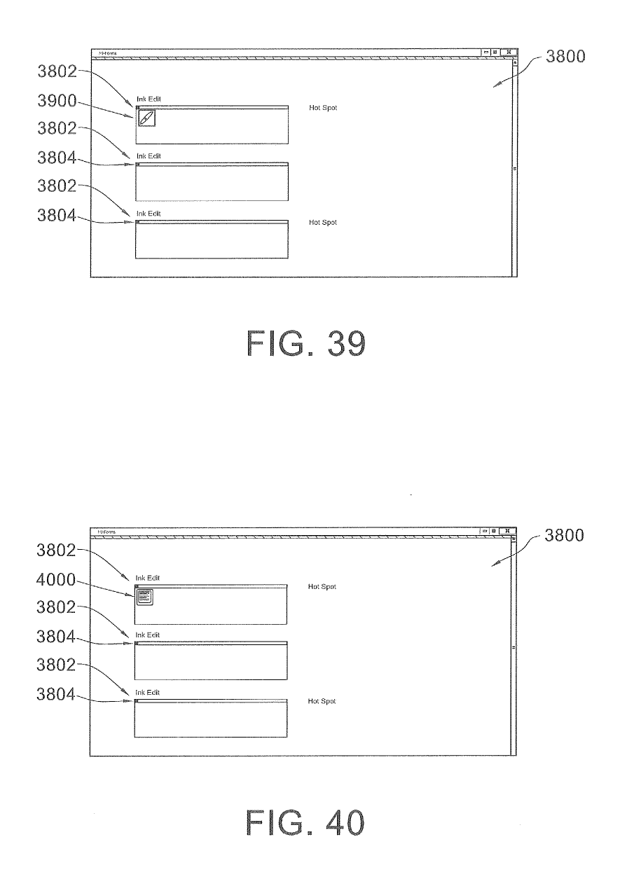

As shown, there may be a small gray box 3804 in the top left corner of each field. As shown in FIG. 39, if a user hovers over this area with their stylus or mouse, an icon may be displayed, such as in an animated fashion, indicating the status of this control in one implementation. In an alternative implementation, the icon may indicate the status to which a user may switch rather than the current status. In the former implementation, as shown in FIG. 39, the top ink edit may currently be in inking mode, and may therefore display a pen icon 3900. Clicking this button may change the field's entry mode into text only editing mode such that the field no longer accepts ink, such as is useful for editing the contents of the field. As shown in FIG. 40, hovering again may now show a text icon 4000 to indicate its new mode. Clicking it again, then, may place it back into inking mode. Such a concept may be used to switch between either of the aforementioned input modalities and/or various other input modalities, including speech and touch.

8. Cursor Placement in Constrained Text Fields

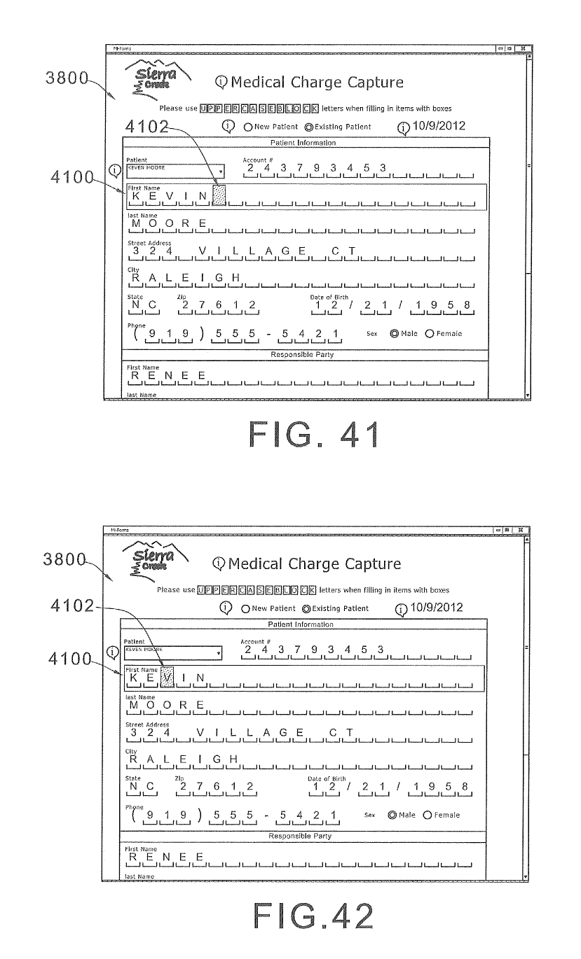

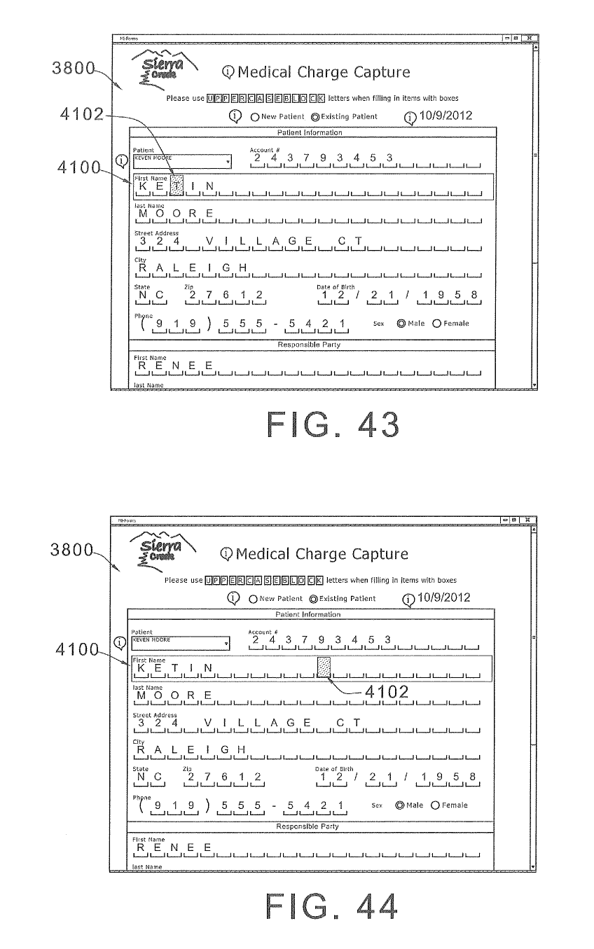

Form applications provide the ability to ink in constrained text fields such that handwriting is converted to text. Example implementations may allow keyboard entry into these fields from the start, but may provide a method to edit specific characters in the field such as by placing a moveable flashing cursor (or any other applicable cursor) directly on the field. FIGS. 41-44 again illustrate the page 2000 of FIG. 20. As shown in FIG. 41, in the first-name field 4100, there may be a cursor 4102 (e.g., animated to be flashing) indicating where keyboard entry will take place. The cursor may be married to a constrained-text field that may otherwise accept inking input through recognition. This cursor may be manipulated through the use of arrow keys, touch gestures, or other applicable manipulation, as shown in FIG. 42 in which the cursor has moved. Typing a character while the cursor is placed over another may replace that character, as shown in FIG. 43. This cursor may also be directly manipulated by using a finger, stylus or mouse to tap on another character in the field, as shown in FIG. 44.

9. Image Annotation

Example implementations may allow ink to be added to a digital image in instances in which it is captured in an appropriate annotation field (e.g., a photo). In this regard, when a user taps/clicks a digital image, example implementations may display the image in a larger interface that allows for inking in a detailed mode. The larger interface may then be closed with the former smaller-version of the image being again presented in the form itself but with the added ink.

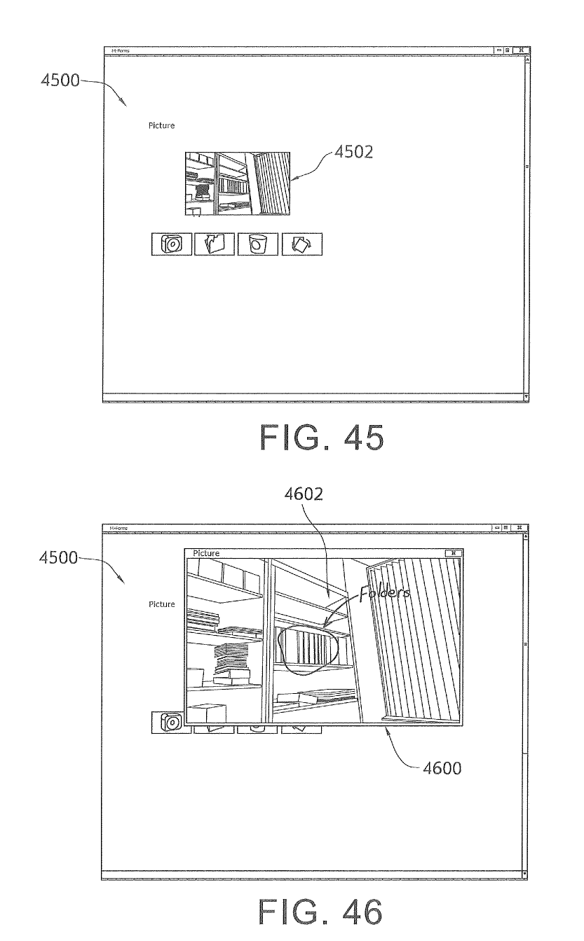

FIGS. 45-47 illustrate an image annotation field 4500 of a form according to one example implementation. The image annotation field may allow a user to either import an existing picture or take a new one. FIG. 45 illustrates such a field immediately after capturing a camera image 4502. As can be seen the actual area allotted for the image may be fairly small. Drawing and annotating directly on top of it may therefore be a cumbersome process. Instead, as shown in FIG. 46, as a user clicks on the image, a larger annotation window 4600 may appears on top of it, here shown with ink 4602 captured. When the user is done annotating, they may dismiss this window, and the ink 4602 may be shown displayed on the form itself in line with the image 4502.

10. Script Response Processing

In some example implementations, the status or state of a form may be altered via a remote server in response to an action taken. FIG. 48 illustrates a multi-page form 4800 including at least pages 4802 and 4804 according to one example. FIG. 48 illustrates a display depicting form script processing and response from a remote server such as server 402. As shown, a touch on a checkbox 4806 (“Cancelled En Route”) may result in a message sent to the server indicating the value change in the form. The server may handle the request and provide a response, which may indicate that the value in the narrative field 4808 be changed to “Cancelled En Route.” Notably, the server may be capable of providing form processing to clients that use different operating systems. In another example, the server may provide a notification message to a relevant party, such as in the case of the previous example, a nearby hospital's emergency department. In a general sense, form script for a form on the server may handle a form data change with any programmable response(s) either in the form itself, within the server itself, or in any externally-accessible resource.

D. Means for Implementation

As suggested above, according to example implementations of the present disclosure, the system and its components including the form designer 100 (e.g., form designer 300, 400), server 102 (e.g., server 200, 302, 402) and client 104 (e.g., client 202, 304, 404) may be implemented by various means. Means for implementing the system and its components may include hardware, alone or under direction of one or more computer program code instructions, program instructions or executable computer-readable program code instructions from a computer-readable storage medium.

In one example, one or more apparatuses may be provided that are configured to function as or otherwise implement the system and its components such as those shown and described herein. In examples involving more than one apparatus, the respective apparatuses may be connected to or otherwise in communication with one another in a number of different manners, such as directly or indirectly via one or more networks, such as explained above.

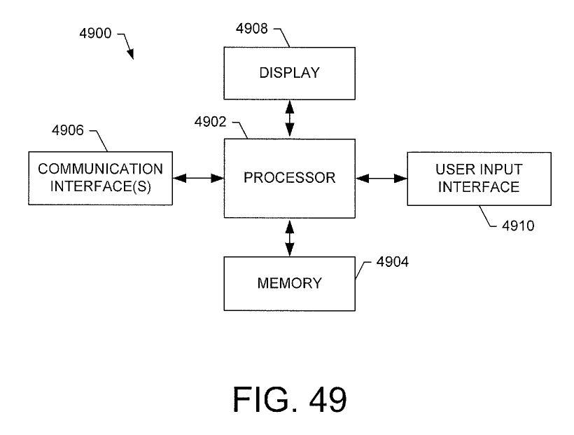

Reference is now made to FIG. 49, which illustrates an apparatus 4900 that may be configured to operate or otherwise function as one or more of a form designer 100 (e.g., form designer 300, 400), server 102 (e.g., server 200, 302, 402) and client 104 (e.g., client 202, 304, 404) according to example implementations of the present disclosure. Generally, the apparatus may comprise, include or be embodied in one or more fixed or portable electronic devices. Examples of suitable electronic devices include a smartphone, tablet computer, laptop computer, desktop computer, workstation computer, server computer or the like. The apparatus may include one or more of each of a number of components such as, for example, a processor 4902 connected to a memory 4904.

The processor 4902 is generally any piece of hardware that is capable of processing information such as, for example, data, computer-readable program code, instructions or the like (generally “computer programs,” e.g., software, firmware, etc.), and/or other suitable electronic information. More particularly, for example, the processor may be configured to execute computer programs, which may be stored onboard the processor or otherwise stored in the memory 4904 (of the same or another apparatus). The processor may be a number of processors, a multi-processor core or some other type of processor, depending on the particular implementation. Further, the processor may be implemented using a number of heterogeneous processor systems in which a main processor is present with one or more secondary processors on a single chip. As another illustrative example, the processor may be a symmetric multi-processor system containing multiple processors of the same type. In yet another example, the processor may be embodied as or otherwise include one or more application-specific integrated circuits (ASICs), field-programmable gate arrays (FPGAs) or the like. Thus, although the processor may be capable of executing a computer program to perform one or more functions, the processor of various examples may be capable of performing one or more functions without the aid of a computer program.

The memory 4904 is generally any piece of hardware that is capable of storing information such as, for example, data, computer programs and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape, a solid-state drive or some combination of the above. Optical disks may include compact disk-read only memory (CD-ROM), compact disk-read/write (CD-R/W), DVD, Blu-ray disk or the like. In various instances, the memory may be referred to as a computer-readable storage medium which, as a non-transitory device capable of storing information, may be distinguishable from computer-readable transmission media such as electronic transitory signals capable of carrying information from one location to another. Computer-readable medium as described herein may generally refer to a computer-readable storage medium or computer-readable transmission medium.

In addition to the memory 4904, the processor 4902 may also be connected to one or more interfaces for displaying, transmitting and/or receiving information. The interfaces may include a communications interface 4906 and/or one or more user interfaces. The communications interface may be configured to transmit and/or receive information, such as to and/or from other apparatus(es), network(s) or the like. The communications interface may be configured to transmit and/or receive information by physical (wireline) and/or wireless communications links. Examples of suitable communication interfaces include a network interface controller (NIC), wireless NIC (WNIC) or the like.

The user interface(s) may include a display 4908, a vibrating apparatus, speakers and/or one or more user input interfaces 4910. The display may be configured to present or otherwise display information to a user, suitable examples of which include a liquid crystal display (LCD), light-emitting diode display (LED), plasma display panel (PDP) or the like. The user input interfaces may be wire line or wireless, and may be configured to receive information from a user into the apparatus, such as for processing, storage and/or display. Suitable examples of user input interfaces include a microphone, image or video capture device, keyboard or keypad, joystick, digital pen, stylus, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by a processor, to implement functions of the systems, subsystems and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

Execution of instructions by a processor, or storage of instructions in a computer-readable storage medium, supports combinations of operations for performing the specified functions. It will also be understood that one or more functions, and combinations of functions, may be implemented by special purpose hardware-based computer systems and/or processors which perform the specified functions, or combinations of special purpose hardware and program code instructions.

Many modifications and other implementations of the disclosure set forth herein will come to mind to one skilled in the art to which these disclosure pertain having the benefit of the teachings presented in the foregoing descriptions and the associated drawings. Therefore, it is to be understood that the disclosure are not to be limited to the specific implementations disclosed and that modifications and other implementations are intended to be included within the scope of any appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of any appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising a processor and a memory storing executable instructions that in response to execution by the processor cause the apparatus to at least:
receive a form definition for a multi-page electronic form including a plurality of fields one or more of which accept input;
display the form in accordance with the form definition, including in at least one instance, display of a focused one of the pages in its entirety, one or more of the fields including respective controls for user interaction with the form, the controls for fields on the focused page being active;
receive an indication of user interaction with the displayed page of the form; and in response to receipt of the indication,
process a plurality of events in accordance with a defined interactive behavior of the displayed form, including an event processed without regard to user interaction with any field of the displayed page.

2. The apparatus of claim 1, wherein the apparatus being caused to display the form includes being caused to further display another, non-focused one of the pages only partially, the controls for the fields on the non-focused page being inactive.

3. The apparatus of claim 2, wherein the apparatus being caused to process the event without regard to user interaction with any field includes being caused to transition focus to the non-focused page in response to user interaction with the non-focused page, the non-focused page thereby becoming the focused page displayed in its entirety and with the controls for its fields being active, and the focused page thereby becoming the non-focused page displayed only partially and with the controls for its fields being inactive.

4. The apparatus of claim 1, wherein the apparatus being caused to process the event without regard to user interaction with any field includes the apparatus being caused to display a menu over a portion of the displayed page in response to user interaction with the respective portion of the displayed page.

5. The apparatus of claim 1, wherein the apparatus being caused to process the event without regard to user interaction with any field includes the apparatus being caused to expand a menu to include a sub-menu in an instance in which the menu is displayed over a portion of the displayed page, and in response to user interaction with the menu.

6. The apparatus of claim 1, wherein the apparatus being caused to process the event without regard to user interaction with any field includes the apparatus being caused to launch a browser to display a web site corresponding to a logo on the displayed page in response to user interaction with the logo.

7. The apparatus of claim 1, wherein the apparatus being caused to process the event without regard to user interaction with any field includes the apparatus being caused to display information about a picture on the displayed page, or activate a camera to take a replacement picture, in response to user interaction with the picture.

8. The apparatus of claim 1, wherein the apparatus being caused to process the event without regard to user interaction with any field includes the apparatus being caused to capture electronic ink data on a portion of the displayed page outside any field and without being associated with any field, in response to user interaction with the respective portion of the displayed page.

9. The apparatus of claim 1, wherein the apparatus being caused to process the event without regard to user interaction with any field includes the apparatus being caused to add a field to the displayed page in response to user interaction with the displayed page outside of any field of the displayed page.

10. The apparatus of claim 1, wherein the apparatus being caused to process the event without regard to user interaction with any field includes the apparatus being caused to display a desktop note over a portion of the displayed page that accepts input.

11. The apparatus of claim 1, wherein the apparatus being caused to process the event without regard to user interaction with any field includes the apparatus being caused to launch a browser to display a web site corresponding to a caption associated with but located in a pre-defined spatial area outside of a field on the displayed page, in response to user interaction with the respective caption.

12. The apparatus of claim 1, wherein the apparatus being caused to process the event without regard to user interaction with any field includes the apparatus being caused to display or play context information, or display validation information, for the form or one or more fields of the form, in response to user interaction with a pre-defined spatial area outside of any field.

13. The apparatus of claim 1, wherein the apparatus being caused to process the plurality of events includes an event processed with regard to user interaction with a field of the displayed page, the apparatus thereby being caused to at least one of:
change an input value in a field of the focused page in response to user interaction with the respective field;
focus on a field of the focused page to accept input in the respective field in response to user interaction with the respective field;
set focus on a box of a multi-box field of the focused page to accept input in the respective box, in an instance in which the display is focused on the multi-box field, and in response to user interaction with the respective box; or
display or play context information for a field in response to user interaction with a caption associated with the respective field, and
wherein the memory stores further executable instructions that for changing the input value, focusing on the field or setting focus on the box, and in response to execution by the processor, causes the apparatus to further update display of the page of the form to contain the changed input value, or the input accepted into the field or box.

14. The apparatus of claim 1, wherein the pages of the multi-page form are ordered and include at least a first page and a second page after the first page, and
wherein in at least one instance, the first and second pages correspond to respective ones of the focused and non-focused pages, and in the respective at least one instance, the apparatus being caused to display the form includes being caused to display the first page centered and in its entirety, and display only a left-most part of the second page to the right of the first page.

15. The apparatus of claim 1, wherein the pages of the multi-page form are ordered and include at least a first page and a second page after the first page, and
wherein in at least one instance, the first and second pages correspond to respective ones of the non-focused and focused pages, and in the respective at least one instance, the apparatus being caused to display the form includes being caused to display the second page centered and in its entirety, and display only a right-most part of the first page to the left of the first page.

16. The apparatus of claim 15, wherein the pages of the multi-page form are ordered and further include a third page after the second page, and
wherein in at least one instance in which the first and second pages correspond to respective ones of the non-focused and focused pages, the third page also corresponds to a non-focused page, and in the respective at least one instance, the apparatus being caused to display the form includes being caused to further display only a left-most part of the third page to the right of the second page.

17. The apparatus of claim 1, wherein the pages of the form include context information identifying the respective pages, and
wherein apparatus being caused to process the event includes being caused to process a plurality of events further including being caused to at least briefly display and then fade from display the context information for at least the focused page and non-focused page.

18. The apparatus of claim 1, wherein the pages of the form include context information identifying the respective pages, and
wherein the apparatus being caused to display the form includes in at least one instance, display of all of the pages of the form in their entireties, and further display of the context information for the respective pages.

19. The apparatus of claim 1, wherein the apparatus being caused to process the event includes being caused to process a plurality of events further including being caused to focus on a field of the focused page to accept input in the respective field in response to user interaction with the respective field, the apparatus being caused to auto-zoom the respective field to a variable level.

20. A method comprising a plurality of operations including at least:
receiving a form definition for a multi-page electronic form including a plurality of fields one or more of which accept input;
displaying the form in accordance with the form definition, including in at least one instance, display of a focused one of the pages in its entirety, one or more of the fields including respective controls for user interaction with the form, the controls for fields on the focused page being active;
receiving an indication of user interaction with the displayed page of the form; and in response to receipt of the indication,
processing a plurality of events in accordance with a defined interactive behavior of the displayed form, including an event processed without regard to user interaction with any field of the displayed page,
wherein the method is performed by an apparatus including a processor and a memory storing executable instructions that in response to execution by the processor cause the apparatus to perform the operations.

21. The method of claim 20, wherein displaying the form includes further displaying another, non-focused one of the pages only partially, the controls for the fields on the non-focused page being inactive.

22. The method of claim 21, wherein processing the event without regard to user interaction with any field includes transitioning focus to the non-focused page in response to user interaction with the non-focused page, the non-focused page thereby becoming the focused page displayed in its entirety and with the controls for its fields being active, and the focused page thereby becoming the non-focused page displayed only partially and with the controls for its fields being inactive.

23. The method of claim 20, wherein processing the event without regard to user interaction with any field includes displaying a menu over a portion of the displayed page in response to user interaction with the respective portion of the displayed page.

24. The method of claim 20, wherein processing the event without regard to user interaction with any field includes expanding a menu to include a sub-menu in an instance in which the menu is displayed over a portion of the displayed page, and in response to user interaction with the menu.

25. The method of claim 20, wherein processing the event without regard to user interaction with any field includes launching a browser to display a web site corresponding to a logo on the displayed page in response to user interaction with the logo.

26. The method of claim 20, wherein processing the event without regard to user interaction with any field includes displaying information about a picture on the displayed page, or activate a camera to take a replacement picture, in response to user interaction with the picture.

27. The method of claim 20, wherein processing the event without regard to user interaction with any field includes capturing electronic ink data on a portion of the displayed page outside any field and without being associated with any field, in response to user interaction with the respective portion of the displayed page.

28. The method of claim 20, wherein processing the event without regard to user interaction with any field includes adding a field to the displayed page in response to user interaction with the displayed page outside of any field of the displayed page.

29. The method of claim 20, wherein processing the event without regard to user interaction with any field includes displaying a desktop note over a portion of the displayed page that accepts input.

30. The method of claim 20, wherein processing the event without regard to user interaction with any field includes launching a browser to display a web site corresponding to a caption associated with but located in a pre-defined spatial area outside of a field on the displayed page, in response to user interaction with the respective caption.

31. The method of claim 20, wherein processing the event without regard to user interaction with any field includes displaying or playing context information, or displaying validation information, for the form or one or more fields of the form, in response to user interaction with a pre-defined spatial area outside of any field.

32. The method of claim 20, wherein processing the plurality of events includes an event processed with regard to user interaction with a field of the displayed page, including at least one of:
changing an input value in a field of the focused page in response to user interaction with the respective field;
focusing on a field of the focused page to accept input in the respective field in response to user interaction with the respective field;
setting focus on a box of a multi-box field of the focused page to accept input in the respective box, in an instance in which the display is focused on the multi-box field, and in response to user interaction with the respective box; or
displaying or playing context information for a field in response to user interaction with a caption associated with the respective field, and
wherein for changing the input value, focusing on the field or setting focus on the box, the plurality of operations further include updating display of the page of the form to contain the changed input value, or the input accepted into the field or box.

33. The method of claim 20, wherein the pages of the multi-page form are ordered and include at least a first page and a second page after the first page, and
wherein in at least one instance, the first and second pages correspond to respective ones of the focused and non-focused pages, and in the respective at least one instance, displaying the form includes displaying the first page centered and in its entirety, and displaying only a left-most part of the second page to the right of the first page.

34. The method of claim 20, wherein the pages of the multi-page form are ordered and include at least a first page and a second page after the first page, and
wherein in at least one instance, the first and second pages correspond to respective ones of the non-focused and focused pages, and in the respective at least one instance, displaying the form includes displaying the second page centered and in its entirety, and displaying only a right-most part of the first page to the left of the first page.

35. The method of claim 34, wherein the pages of the multi-page form are ordered and further include a third page after the second page, and
wherein in at least one instance in which the first and second pages correspond to respective ones of the non-focused and focused pages, the third page also corresponds to a non-focused page, and in the respective at least one instance, displaying the form includes further displaying only a left-most part of the third page to the right of the second page.

36. The method of claim 20, wherein the pages of the form include context information identifying the respective pages, and
wherein processing the event includes processing a plurality of events further including at least briefly displaying and then fading from display the context information for at least the focused page and non-focused page.

37. The method of claim 20, wherein the pages of the form include context information identifying the respective pages, and
wherein displaying the form includes in at least one instance, displaying of all of the pages of the form in their entireties, and further displaying the context information for the respective pages.

38. The method of claim 20, wherein processing the event includes processing a plurality of events further including focusing on a field of the focused page to accept input in the respective field in response to user interaction with the respective field, including auto-zooming the respective field to a variable level.

39. A computer-readable storage medium having computer-readable program code portions stored therein that, in response to execution by a processor, cause an apparatus to at least:
receive a form definition for a multi-page electronic form including a plurality of fields one or more of which accept input;
display the form in accordance with the form definition, including in at least one instance, display of a focused one of the pages in its entirety, one or more of the fields including respective controls for user interaction with the form, the controls for fields on the focused page being active;
receive an indication of user interaction with the displayed page of the form; and in response to receipt of the indication,
process a plurality of events in accordance with a defined interactive behavior of the displayed form, including an event processed without regard to user interaction with any field of the displayed page.

40. The computer-readable storage medium of claim 39, wherein the apparatus being caused to display the form includes being caused to further display another, non-focused one of the pages only partially, the controls for the fields on the non-focused page being inactive.

41. The computer-readable storage medium of claim 40, wherein the apparatus being caused to process the event without regard to user interaction with any field includes being caused to transition focus to the non-focused page in response to user interaction with the non-focused page, the non-focused page thereby becoming the focused page displayed in its entirety and with the controls for its fields being active, and the focused page thereby becoming the non-focused page displayed only partially and with the controls for its fields being inactive.

42. The computer-readable storage medium of claim 39, wherein the apparatus being caused to process the event without regard to user interaction with any field includes the apparatus being caused to display a menu over a portion of the displayed page in response to user interaction with the respective portion of the displayed page.

43. The computer-readable storage medium of claim 39, wherein the apparatus being caused to process the event without regard to user interaction with any field includes the apparatus being caused to expand a menu to include a sub-menu in an instance in which the menu is displayed over a portion of the displayed page, and in response to user interaction with the menu.

44. The computer-readable storage medium of claim 39, wherein the apparatus being caused to process the event without regard to user interaction with any field includes the apparatus being caused to launch a browser to display a web site corresponding to a logo on the displayed page in response to user interaction with the logo.

45. The computer-readable storage medium of claim 39, wherein the apparatus being caused to process the event without regard to user interaction with any field includes the apparatus being caused to display information about a picture on the displayed page, or activate a camera to take a replacement picture, in response to user interaction with the picture.

46. The computer-readable storage medium of claim 39, wherein the apparatus being caused to process the event without regard to user interaction with any field includes the apparatus being caused to capture electronic ink data on a portion of the displayed page outside any field and without being associated with any field, in response to user interaction with the respective portion of the displayed page.

47. The computer-readable storage medium of claim 39, wherein the apparatus being caused to process the event without regard to user interaction with any field includes the apparatus being caused to add a field to the displayed page in response to user interaction with the displayed page outside of any field of the displayed page.

48. The computer-readable storage medium of claim 39, wherein the apparatus being caused to process the event without regard to user interaction with any field includes the apparatus being caused to display a desktop note over a portion of the displayed page that accepts input.

49. The computer-readable storage medium of claim 39, wherein the apparatus being caused to process the event without regard to user interaction with any field includes the apparatus being caused to launch a browser to display a web site corresponding to a caption associated with but located in a pre-defined spatial area outside of a field on the displayed page, in response to user interaction with the respective caption.

50. The computer-readable storage medium of claim 39, wherein the apparatus being caused to process the event without regard to user interaction with any field includes the apparatus being caused to display or play context information, or display validation information, for the form or one or more fields of the form, in response to user interaction with a pre-defined spatial area outside of any field.

51. The computer-readable storage medium of claim 39, wherein the apparatus being caused to process the plurality of events includes an event processed with regard to user interaction with a field of the displayed page, the apparatus thereby being caused to at least one of:
change an input value in a field of the focused page in response to user interaction with the respective field;
focus on a field of the focused page to accept input in the respective field in response to user interaction with the respective field;
set focus on a box of a multi-box field of the focused page to accept input in the respective box, in an instance in which the display is focused on the multi-box field, and in response to user interaction with the respective box; or
display or play context information for a field in response to user interaction with a caption associated with the respective field, and
wherein the computer-readable storage medium has further computer-readable program code portions stored therein that for changing the input value, focusing on the field or setting focus on the box, and in response to execution by the processor, cause the apparatus to further update display of the page of the form to contain the changed input value, or the input accepted into the field or box.

52. The computer-readable storage medium of claim 39, wherein the pages of the multi-page form are ordered and include at least a first page and a second page after the first page, and
wherein in at least one instance, the first and second pages correspond to respective ones of the focused and non-focused pages, and in the respective at least one instance, the apparatus being caused to display the form includes being caused to display the first page centered and in its entirety, and display only a left-most part of the second page to the right of the first page.

53. The computer-readable storage medium of claim 39, wherein the pages of the multi-page form are ordered and include at least a first page and a second page after the first page, and
wherein in at least one instance, the first and second pages correspond to respective ones of the non-focused and focused pages, and in the respective at least one instance, the apparatus being caused to display the form includes being caused to display the second page centered and in its entirety, and display only a right-most part of the first page to the left of the first page.

54. The computer-readable storage medium of claim 53, wherein the pages of the multi-page form are ordered and further include a third page after the second page, and
wherein in at least one instance in which the first and second pages correspond to respective ones of the non-focused and focused pages, the third page also corresponds to a non-focused page, and in the respective at least one instance, the apparatus being caused to display the form includes being caused to further display only a left-most part of the third page to the right of the second page.

55. The computer-readable storage medium of claim 39, wherein the pages of the form include context information identifying the respective pages, and
wherein apparatus being caused to process the event includes being caused to process a plurality of events further including being caused to at least briefly display and then fade from display the context information for at least the focused page and non-focused page.

56. The computer-readable storage medium of claim 39, wherein the pages of the form include context information identifying the respective pages, and
wherein the apparatus being caused to display the form includes in at least one instance, display of all of the pages of the form in their entireties, and further display of the context information for the respective pages.

57. The computer-readable storage medium of claim 39, wherein the apparatus being caused to process the event includes being caused to process a plurality of events further including being caused to focus on a field of the focused page to accept input in the respective field in response to user interaction with the respective field, the apparatus being caused to auto-zoom the respective field to a variable level.
